(19) United States
(12) Patent Application Publication
(10) Pub. No.: US 2012/0203598 A1
(43) Pub. Date: Aug. 9, 2012

(54) File Server System and Method of Providing a Marketing Performance and Accountability Audit

(75) Inventor: Laura Patterson, Austin, TX (US)

(73) Assignee: VISIONEDGE MARKETING, Austin, TX (US)

(21) Appl. No.: 13/356,318

(22) Filed: Jan. 23, 2012

Related U.S. Application Data
(60) Provisional application No. 61/441,272, filed on Feb. 9, 2011.

(51) Int. Cl. G06Q 10/00

(52) U.S. Cl. 705/7.42; 705/7.11

(57) ABSTRACT

A computer-readable medium includes instructions that, when executed by a processor, cause the processor to selectively acquire first data corresponding to multiple categories of interest with respect to a marketing organization as a whole. When executed, the instructions further cause the processor to selectively acquire second data corresponding to multiple workflow categories with respect to individuals and organizations within the marketing organization and to generate at least one audit report based on at least one of the first data and the second data.

### CROSS-REFERENCE TO RELATED APPLICATION(S)

This application is a non-provisional of and claims priority to U.S. Provisional Patent Application No. 61/441,272 filed on Feb. 9, 2011 and entitled “Systems and Methods of Providing a Marketing Performance and Accountability Audit,” which is incorporated herein by reference in its entirety.

### FIELD

The present disclosure is generally related to computer-aided marketing tools, and more particularly to systems and methods marketing performance and accountability audit for auditing the performance and accountability of the marketing function within an organization.

### BACKGROUND

In general, the discipline of marketing is necessarily relatively broad. However, the discipline can generally be loosely grouped into a number of functions, such as strategic marketing, product marketing, marketing communications and field marketing, which are some of the most common groupings. In its entirety, marketing is a process by which one identifies the needs and wants of the people, determines and creates products/services to meet the needs and wants, establishes the value for the product/service, makes the product convenient for the customer to buy, and communicates information about the products with messages through channels that resonate with buyers. The marketing function when performing well contributes to the perception of the organization and the performance of products in the market. The value of marketing derives from its ability to develop knowledge and skills that define market opportunities and design and implement the strategy that connects customers with products.

However, like any organization, a marketing group may have its strengths and its weaknesses. Traditionally, assessing the capabilities (the strengths and weaknesses) of a marketing organization involved a “black art” that relied on the experience of the people performing the evaluation. Unfortunately, such evaluations (often performed by outside consultants) may deviate substantially from the perceptions of the corporate leadership and may aggravate existing grievances between the corporate leadership and the marketing group without offering solutions for improvement.

### BRIEF DESCRIPTION OF THE DRAWINGS

FIG. 1 is block diagram of an embodiment of a system configured to provide a marketing performance and accountability audit of a marketing organization.

FIG. 2 is a flow diagram of an embodiment of a method of providing a marketing performance and accountability audit.

FIGS. 3-16 depict embodiments of user interfaces for receiving user input with respect to an overall objective assessment of a marketing organization across thirteen categories of an organizations' marketing performance and their subcategories and twenty-seven (27) marketing workflow operations and their associated subcategories.

FIGS. 17-23 depict embodiments of user interfaces for receiving user input relating to a detailed assessment of the marketing organization across seven subcategories within a measurement category of the overall objective assessment.

FIG. 24 is a diagram of an embodiment of a user interface including a market strength dashboard illustrating the combined section scores for the marketing organization.

FIG. 25 is a chart of an embodiment of a category score snapshot produced by the system of FIG. 1 for a particular marketing organization.

FIG. 26 is a chart of an embodiment of a metrics competency score snapshot produced by the system of FIG. 1 for a particular marketing organization.

FIG. 27 is a bar graph of an embodiment of purpose scores produced by the system of FIG. 1 for a particular marketing organization.

FIG. 28 is a bar graph of an embodiment of goals scores produced by the system of FIG. 1 for a particular marketing organization.

FIG. 29 is a bar graph of an embodiment of alignment scores produced by the system of FIG. 1 for a particular marketing organization.

FIG. 30 is a flow diagram of an embodiment of a method for customizing a workflow skills assessment process for a particular marketing organization.

FIG. 31-33 depict embodiments of user interfaces for receiving information about individuals within the marketing organization.

FIG. 34 depicts an embodiment of a user interface for displaying the marketing performance and accountability audit with respect to the marketing organization and individuals within the marketing organization.

FIG. 35 is a graph of an embodiment of an overall snapshot of the skills competency and proficiency for the industry and program managers as a group.

FIG. 36 is a graph of an embodiment of a snapshot of skills, competency and proficiency of the marketing team for several marketing operation categories.

FIG. 37 is a graph of an embodiment of an opportunity development overview depicting opportunity development skills of the marketing team.

FIG. 38 is a graph of an embodiment of a product marketing overview depicting the product marketing skills of the marketing team.

FIG. 39 is a graph of an embodiment of a customer marketing overview depicting the customer marketing skills of the marketing team.

FIG. 40 is a graph of an embodiment of a marketing operations overview depicting the overall marketing operations of the marketing team.

FIG. 41 is a diagram depicting an embodiment of chart summarizing findings for each workflow operation for each person and providing averages for each group and for the marketing team.

In the following description, the use of the same reference numerals in different drawings indicates similar or identical items.

### DETAILED DESCRIPTION OF ILLUSTRATIVE EMBODIMENTS

Embodiments of systems and methods are described below that provide a methodology and a tool for evaluating marketing organizations to identify areas where a particular marketing organization is weak or tacking and where the organization may be performing well. The systems and method implement two distinct aspects, which can be performed individually or together: an overall objective assessment of a marketing organization across thirteen categories of an organizations marketing performance and a workflow skills assessment of twenty-seven distinct categories of marketing skills (at an organizational level and at an individual skills level).

The user can select whether to perform one or both assessments. Based on the user's selection, the system prompts the user to answer a sequence of questions (either to assist an interviewer through an interview process involving multiple interviewees or to prompt the user to complete a survey that other users will also independently complete). The answers are collected and analyzed (automatically) to produce an audit report about the marketing organization and/or the individuals. The audit may also include recommendations for improving the marketing organization, enhancing marketing skills of individuals within the marketing organization, or any combination thereof.

The systems and methods described below utilize a marketing audit toot to collect information for examining an organization's alignment, processes, systems, tools, and skills related to performance measurement and management (“The Overall Assessment”). The tool is designed to identify areas where an organization is weak or lacking as well as where the organization may be performing well relative to the above-dimensions. The overall assessment and audit process consists of all or a combination of four phases described in Table 1 below.

TABLE 1
Assessment and Audit Process Phases.

| | |
|---|---|
| Phase 1 | On-site (or on-line) interviews with Marketing and executive |
| | staff using a pre-approved discussion guide. |
| Phase 2 | On-site discussion and audit of practices and processes with the |
| | Marketing team or on-line survey by members of the marketing |
| | team. |
| Phase 3 | Review (automated) of various internal marketing and business |
| | documents, such as the annual marketing plan and budget, job |
| | descriptions and responsibilities, program plans and evaluations |
| | and marketing performance reports. |
| Phase 4 | Completion online survey by marketing personnel, executive |
| | staff, or other staff within the organization. |

The systems and methods described below utilize the marketing audit tool to collect information for examining the marketing organization from the perspective of the individuals and groups that make up the marketing organization (“The Workflow Skills Assessment”). The Individual Assessment methodology involves examining an organization's alignment, processes, systems, tools, and skills related to marketing performance and the primary areas of the marketing workflow. The marketing audit tool provides interfaces for gathering information about the marketing organization from the perspective of the marketing team and from the perspective of management, automatically processes and interpolates the information, and produces various reports that can be viewed and used to improve the marketing organization. Improvement of a marketing organization requires investment by the management team, and the reports can provide insights as to how to use such investments to improve the return on investment.

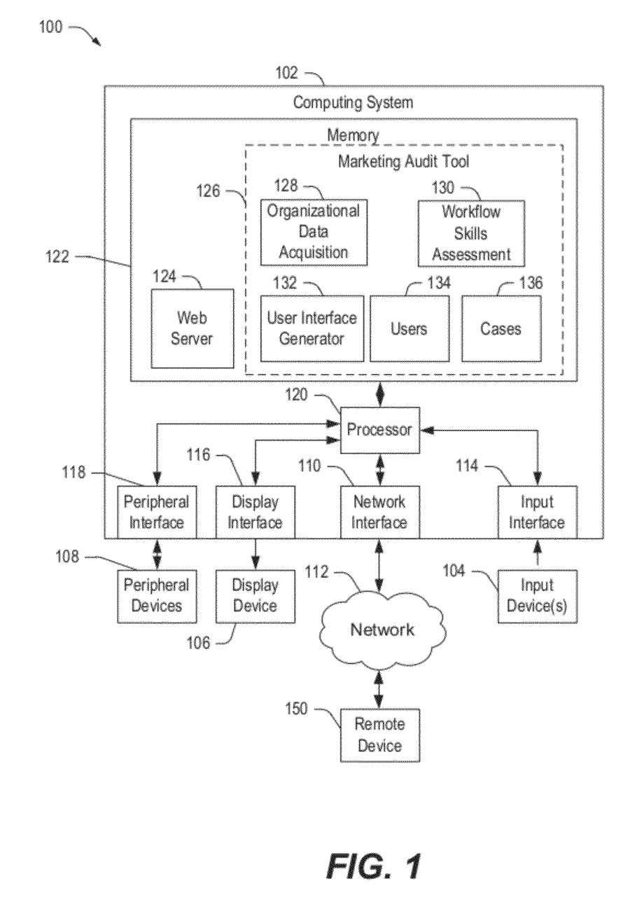

FIG. 1 is block diagram of an embodiment of a system 100 configured to provide a marketing performance and accountability audit. System 100 includes a computing system 102 connected to one or more input devices 104 (such as a keyboard, keypad, mouse, stylus, microphone, a memory device, or other input device), a display device 106 (such as a liquid crystal display (LCD)), and one or more peripheral devices 108 (such as a printer, a scanner, or another type of peripheral device). Computing system 102 is connected to a network 112, such as the Internet, and is configured to communicate with one or more remote devices, such as remote device 150. In an embodiment, computing system 102 operates as a web server accessible by remote device 150 using an Internet browser application executed by a processor of remote device 150. In another embodiment, computing system 102 is a standalone computing system configurable to communicate with other devices over a network.

Computing system 102 includes a network interface 110 connected to network 112. Computing system 102 further includes a processor 120 connected to network interface 110. Processor 120 is connected to input interface 114, which connects to the one or more input devices 104, to display interface 116, which connects to display device 106, and to peripheral interface 118, which connects to the one or more peripheral devices 108. Processor 120 is also connected to a memory 122, which stores data and processor-executable instructions.

Memory 122 includes a web server application 124 that, when executed, causes processor 120 to provide web services to remote device 150 through network 112. Such web services can include serving web pages, such as active server pages, eXtensible Markup Language (XML) documents, and other types of web pages, including user-selectable elements and other information to remote device 150. Memory 122 further includes a marketing audit tool 126 that can be accessed by a user to perform an audit of a marketing organization. Marketing audit tool 126 includes an organization data acquisition module 128 configured to generate prompts and other information, which can be used by user interface generator 132 to produce web pages or graphical user interfaces including user-selectable elements and user prompts designed to acquire information about individuals within the marketing group and about the marketing group as a whole. Marketing audit tool 126 further includes a workflow skills assessment module 130 configured to process and analyze the skills data obtained using organization data acquisition module 128. Workflow skills assessment tool 130 operates in conjunction with user interface generator 132 to produce reports and other information, including a marketing organization audit, for reviewing and assessing the skills of the marketing organization. Marketing audit tool 126 also includes user information 134 and cases information 136. In operation, an audit for a particular marketing organization is stored as a case, to differentiate the particular audit from an audit of a different organization. Further, individual users may have access only to their cases and not to cases of other individuals. User information may include access information, roles (administrative, user, guest, etc.) and other information.

In an example, a user may access marketing audit toot 126 through a web-page based form rendered within an Internet browser application executing on a processor of remove device 150 and provided by web server 124 executed by processor 110 of computing system 102. In one possible example, a web page or a sequence of web pages prompt the user to answer multiple questions about the marketing organization. In some instances, the web pages may include embedded scripts that allow for at least some user-side processing of the data entered by the user. In other instances, computing system 102 processes data submitted by the user via remote device 150 through network 112.

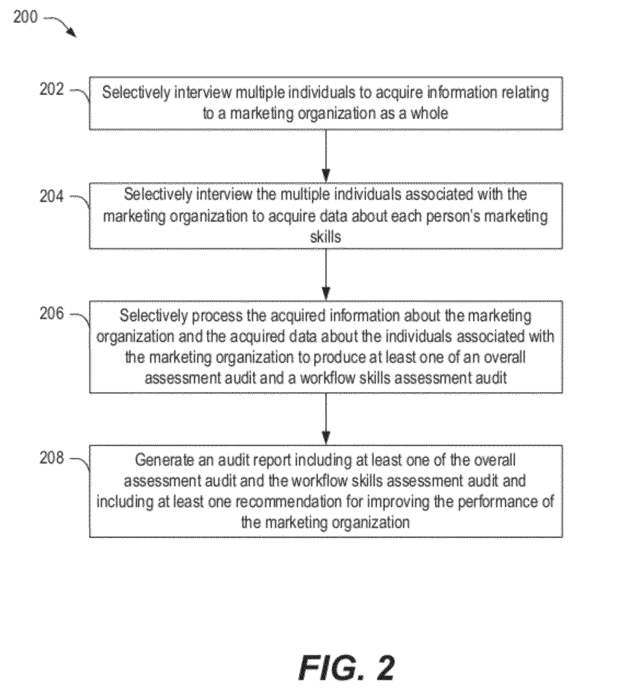

FIG. 2 is a flow diagram of an embodiment of a method 200 of providing a marketing performance and accountability audit. At 202, multiple individuals are selectively interviewed to acquire information relating to a marketing organization as a whole, i.e., an overall assessment of the marketing organization. The interviews may be conducted by an individual and the responses entered into computing system 102, or alternatively computing system 102 can automatically generate user interfaces to query multiple individuals to acquire the desired information.

Advancing to 204, the data related to the performance of the organization and/or the skills and capabilities of the marketing organization and/or its individuation are acquired either through individual interviews or by individuals completing a survey completed manually or using a web-based tool. As before, the interviews may be conducted by a user and the user may then enter the data into the system. Alternatively, the data may be collected by completing one or more surveys manually or via access a web page.

Continuing to 206, marketing audit tool 126 selectively processes the acquired information about the marketing organization and the acquired data about the individuals associated with the marketing organization to produce at least one of an overall assessment audit and/or a workflow skills assessment audit. A user may interact with marketing audit tool 126 to select the desired audit. Alternatively, marketing audit tool 126 may automatically determine the audit to perform based on the information and/or data acquired.

Advancing to 208, marketing audit tool 126 generates an audit report including at least one of the overall assessment audit and the workflow skills assessment audit and including at least one recommendation for improving the performance of the marketing organization. The audit report may be provided to a display (such as display device 106 in FIG. 1) or to a remote device (such as remote device 150). In some instances, the audit report may be provided to a printer, such as a printer connected to peripheral interface 118.

It should be appreciated that the overall assessment audit represents an assessment of the marketing organization as a whole. The workflow skills assessment drills down into individual and group skills within the marketing organization, providing a more granular view of the marketing data. Either or both of the assessments may be performed to characterize aspects of the marketing organization and to prepare a plan for enhancing performance of the marketing organization.

In the following discussion, the process of performing the overall assessment is discussed first in conjunction with multiple graphical user interfaces. Subsequently, the process of performing the workflow skills assessment is discussed in conjunction with a flow diagram and various user interfaces and outputs.

### A. The Overall Assessment

in the first phase, processor 120 executes organizational data acquisition module 128 to acquire and process data to provide an overall objective assessment across thirteen categories of an organization's marketing performance. The thirteen categories include 1) Purpose, 2) Goals, 3) Alignment, 4) Measurement, 5) People, 6) Competition, 7) Customer, 8) Programs, 9) Infrastructure, 10) Support, 11) Evolution, 12) Investment, and 13) Functionality. Each of the thirteen categories can be divided into multiple subcategories. In a particular embodiment, two hundred twenty eight subcategories comprise the thirteen categories. In the second phase, the marketing audit tool provides a detailed assessment across seven subcategories within the Measurement Category (category 4 above) of the marketing department's metrics proficiency and metrics competency. The seven sub-categories in the Measurement Category include 1) Metrics Process, 2) Metrics Targets, 3) Metrics Alignment, 4) Metrics Reporting 5) Metrics Skills and Training, 6) Metrics Proficiency, and 7) Metrics Data and Infrastructure.

The marketing audit tool 126, in conjunction with organizational data acquisition module 128 and web server 124, provides an interface through which the user “scores” the organization. The audit toot is has the rating and weighting for each category preconfigured, enabling the tool to provide a score for each category and subcategory based on the score assigned for each. The marketing audit tool applies the ratings and weights to calculate a point total for each capability within a category and its subcategories. The point totals for each capability are used to calculate a final score for each subcategory that are then used to calculate the category total score. The sub-category scores and category total scores are reported in the Findings and Analysis section of this report. The user assesses the organization's capabilities for each element associated with the category using a score of zero to five (0-5) and not applicable, where:
0—If the statement is completely untrue;
1—If the statement is only minimally true;
2—If the statement is true but the department is performing below average compared to other organizations within the company or other marketing organizations you're familiar with;
3—If the statement is true but the department is only average compared to other organizations within the company or to other marketing organizations you're familiar with;
4—If the statement is true and while improvements could be made, the organization is at par or better than other organizations in the company or other marketing organizations you're familiar with;
5—The statement is completely true and the department can serve as an example of best-in-class for other organizations within the company and even other marketing organizations; and
6—NA is selected if the item is not applicable to the organization or person.

The online survey provides 110 questions that map to the tool database. Using the same scale, users input their score for each question. It should be appreciated that, in a particular embodiment, the ratings and weightings in the marketing audit tool are preconfigured so that the user (regardless of who that user is) can interact with the user interface to provide the scores for each of the questions, and the marketing audit tool performs the calculations based on the scores. In some embodiments, an administrator may have access to the ratings and weightings, making it possible for the customer (or a consultant) to customize the ratings and weightings for the particular organization.

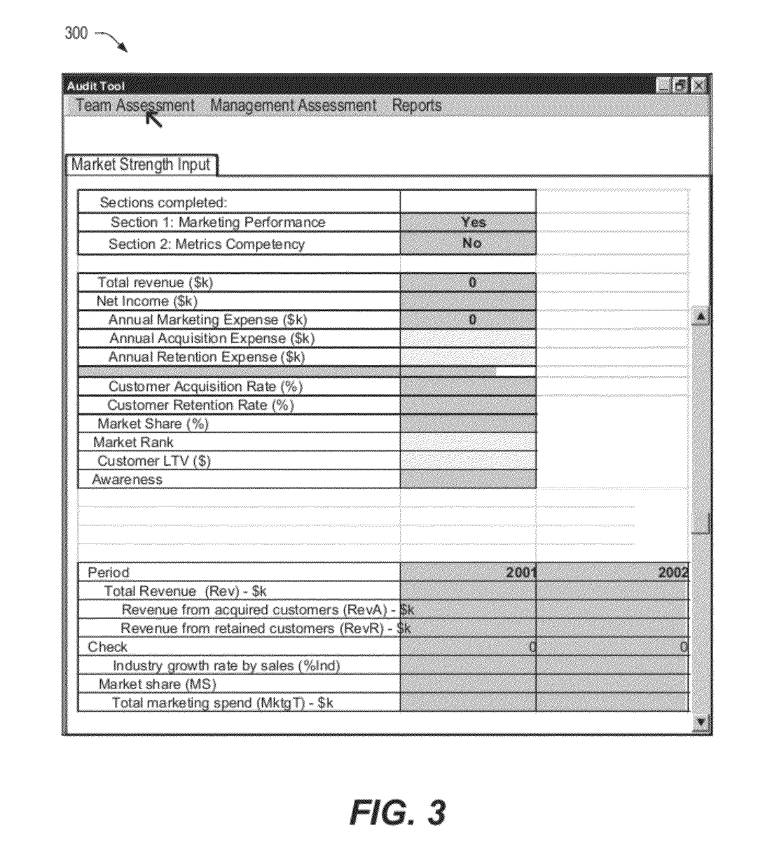

As mentioned above, organizational data acquisition module 128 causes processor 120 to generate one or more user interfaces, which can be presented to a user via a web page (for example). The user interfaces include user-selectable options and inputs for receiving data related to the marketing organization Examples of possible user interfaces for receiving the data are described below with respect to FIGS. 3-16.

FIGS. 3-16 depict embodiments of user interfaces for receiving user input with respect to an overall objective assessment of a marketing organization across thirteen categories of an organizations' marketing performance. FIG. 3 depicts an embodiment of a user interface 300 for receiving market strength data about the marketing organization, including total revenue, net income, market share, market rank, etc. User interface 300 includes a large number of inputs, which extend beyond the viewable window. An example that includes some of the additional inputs is included within Appendix A. Once the data is entered, the user may select a “submit” or “next” button (not shown) at the bottom of the page.

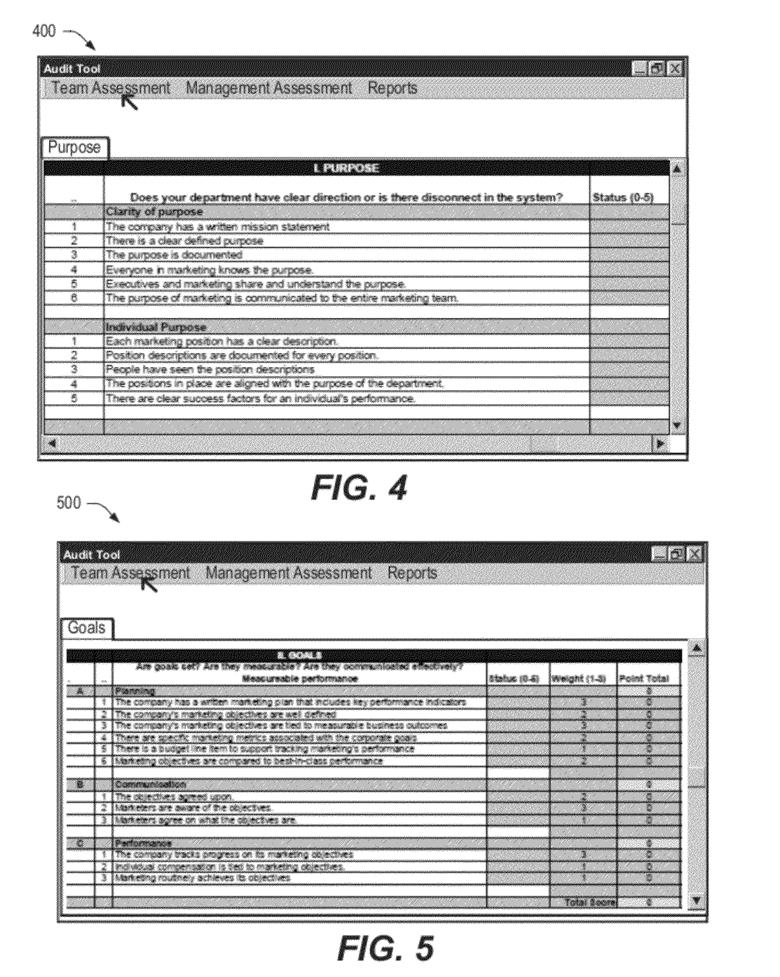

FIG. 4 is an embodiment of a user interface 400 for receiving user inputs to answer questions related to the “Purpose” of the organization. For example, the user's rate the marketing organization on a scale of 0 to 5 (where zero is a low score and five is a high score) for each of the questions, including “The company has a written mission statement”; “there is a clear defined purpose”; “the purpose is documented”, etc. The user interface 400 acquires information about whether the marketing organization has a clear direction or if there is a disconnect in the system. An example that includes some of the additional inputs is included within Appendix A. Once again, the questions extend beyond the viewable window, and the additional questions are accessible via a scroll bar. Once the data is entered, the user may select a “submit” or “next” button (not shown) at the bottom of the page.

FIG. 5 is an embodiment of a user interface 500 for receiving user inputs to answer questions related to the “Goals” of the organization. User interface 500 collects information about whether the marketing organization has set goals, whether the goals are measurable, whether they are effectively communicated, and whether performance metrics are also measurable. As described above, the user answers each of the questions using a numeric rating on a scale of zero to five. An example that includes some of the additional inputs is included within Appendix A. Once the data is entered, the user may select a “submit” or “next” button (not shown) at the bottom of the page.

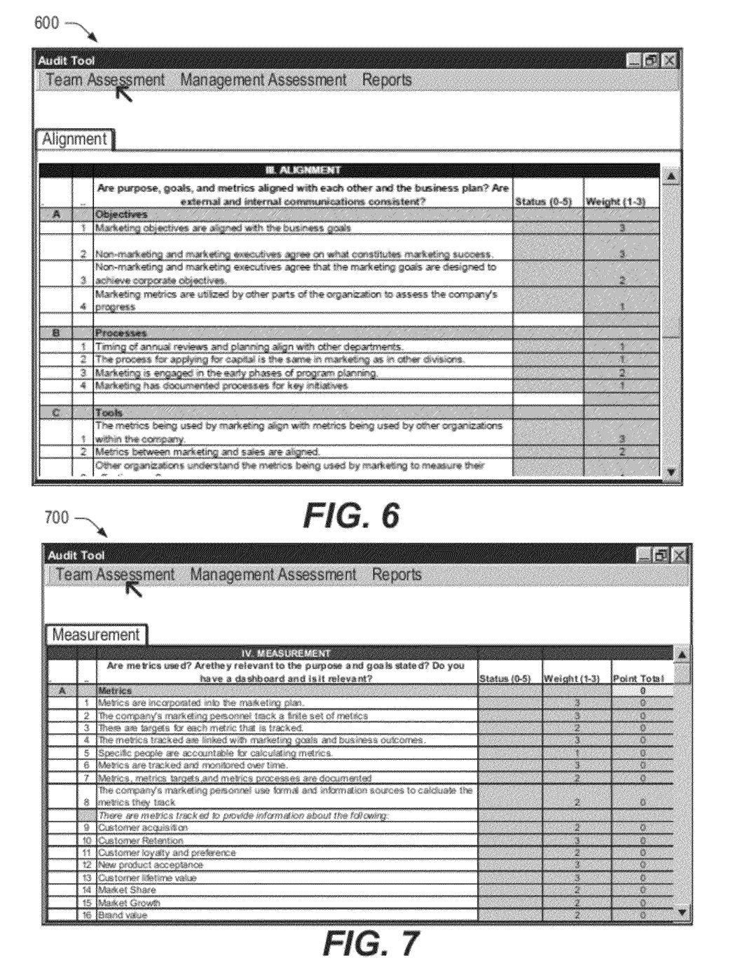

FIG. 6 is an embodiment of a user interface 600 for receiving user data related to the alignment of the goals to the business plans and the purpose. User interface 600 acquires data corresponding to the alignment of the business objectives, processes, tools, and other aspects. In particular, user interface 600 acquires information to determine whether the purpose, goals, and metrics are aligned with each other and with the business plan and whether external and internal communications are consistent. As described above, the user answers each of the questions using a numeric rating on a scale of zero to five. An example that includes some of the additional inputs is included within Appendix A. Once the data is entered, the user may select a “submit” or “next” button (not shown) at the bottom of the page.

FIG. 7 is an embodiment of a user interface 700 for receiving user data related to metrics. User interface 700 includes questions and user-selectable options relating to measurement. For example, user interface 700 collects data to determine whether metrics are used and whether they are relevant to the purpose and goals stated. As described above, the user answers each of the questions using a numeric rating on a scale of zero to five. An example that includes some of the additional inputs is included within Appendix A. Once the data is entered, the user may select a “submit” or “next” button (not shown) at the bottom of the page.

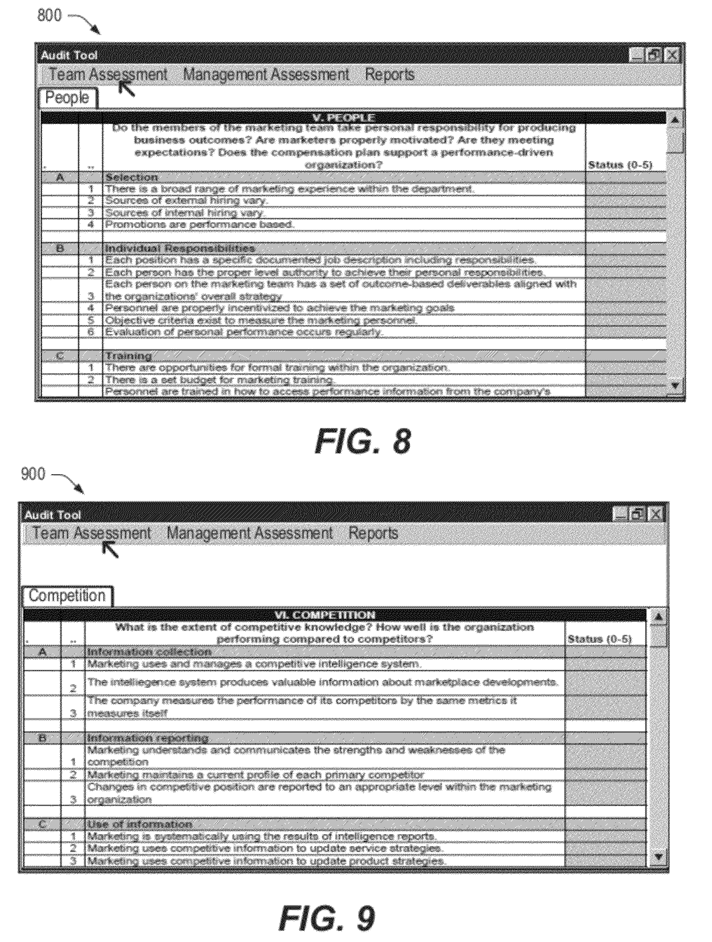

FIG. 8 is an embodiment of a user interface 800 for receiving user data related to people within the marketing organization. User interface 800 includes questions and user-selectable options for acquiring information about whether the members of the marketing team take personal responsibility for producing business outcomes, whether they are properly motivated, whether they are meeting expectations, and whether the compensation plan supports a performance-driven organization. As described above, the user answers each of the questions using a numeric rating on a scale of zero to five. An example that includes some of the additional inputs is included within Appendix A. Once the data is entered, the user may select a “submit” or “next” button (not shown at the bottom of the page.

FIG. 9 is an embodiment of a user interface 900 for receiving user data related to competitive knowledge within the marketing organization. User interface 900 includes questions and user-selectable options for acquiring information about the extent of the competitive knowledge within the marketing organization and about how well the organization is performing relative to its competitors. As described above, the user answers each of the questions using a numeric rating on a scale of zero to five. An example that includes some of the additional inputs is included within Appendix A. Once the data is entered, the user may select a “submit” or “next” button (not shown) at the bottom of the page.

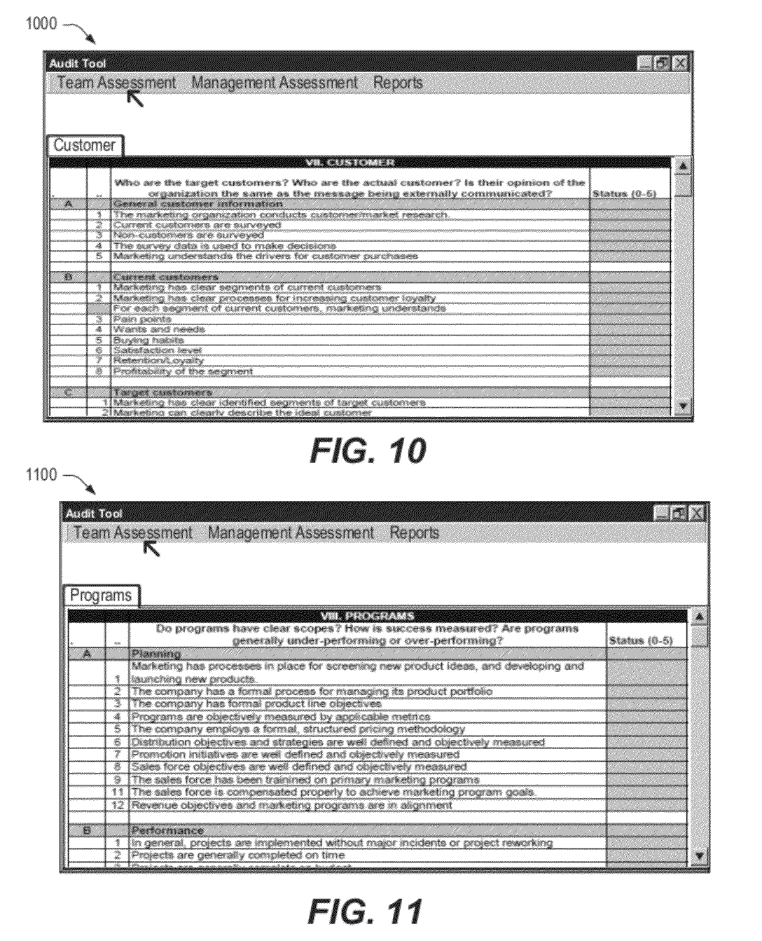

FIG. 10 is an embodiment of a user interface 1000 for receiving user data related to customers. User interface 1000 includes questions and user-selectable options for acquiring information about the target customers, the actual customers, and their opinion of the organization. As described above, the user answers each of the questions using a numeric rating on a scale of zero to five. An example that includes some of the additional inputs is included within Appendix A. Once the data is entered, the user may select a “submit” or “next” button (not shown) at the bottom of the page.

FIG. 11 is an embodiment of a user interface 1100 for receiving user data related to marketing programs of the organization. User interface 1100 includes questions and user-selectable options for acquiring information about whether the marketing programs have clear scopes, about how success is measured, and about the general performance of such programs. As described above, the user answers each of the questions using a numeric rating on a scale of zero to five. An example that includes some of the additional inputs is included within Appendix A. Once the data is entered, the user may select a “submit” or “next” button (not shown) at the bottom of the page.

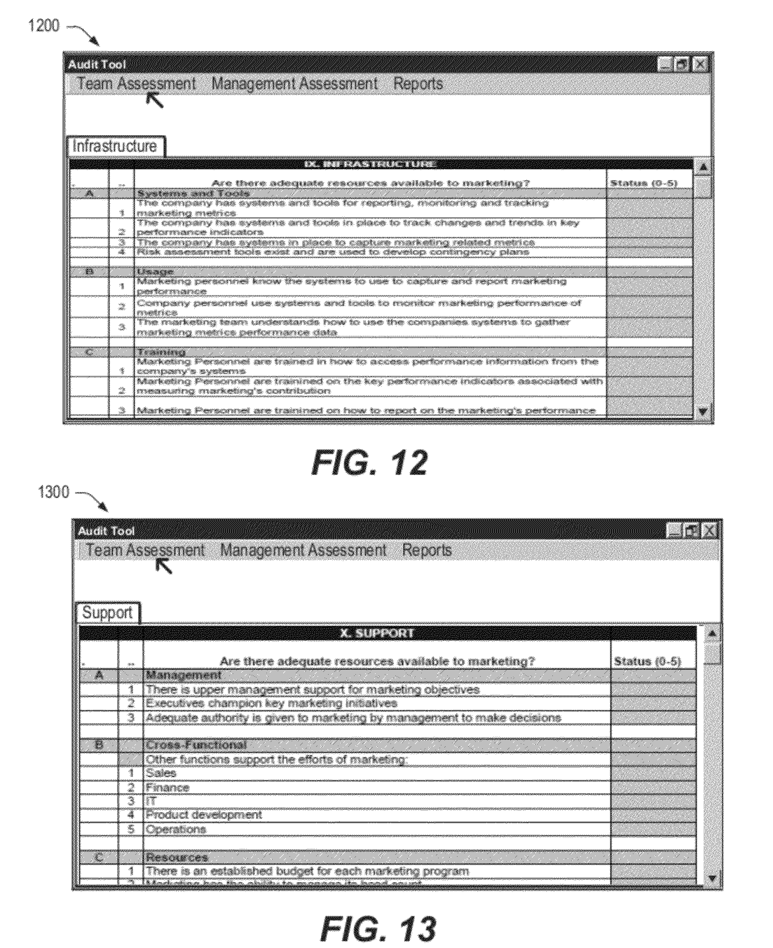

FIG. 12 is an embodiment of a user interface 1200 for receiving user data related to the infrastructure of the organization. User interface 1200 includes questions and user-selectable options for acquiring information about the infrastructure of the organization, and more particularly whether there are adequate resources available to marketing. As described above, the user answers each of the questions using a numeric rating on a scale of zero to five. An example that includes some of the additional inputs is included within Appendix A. Once the data is entered, the user may select a “submit” or “next” button (not shown) at the bottom of the page.

FIG. 13 is an embodiment of a user interface 1300 for receiving user data related to marketing support within the organization. User interface 1300 includes questions and user-selectable options for acquiring information about whether the marketing program has adequate resources with respect to management, cross-functional efforts, and other resources. As described above, the user answers each of the questions using a numeric rating on a scale of zero to five. An example that includes some of the additional inputs is included within Appendix A. Once the data is entered, the user may select a “submit” or “next” button (not shown) at the bottom of the page.

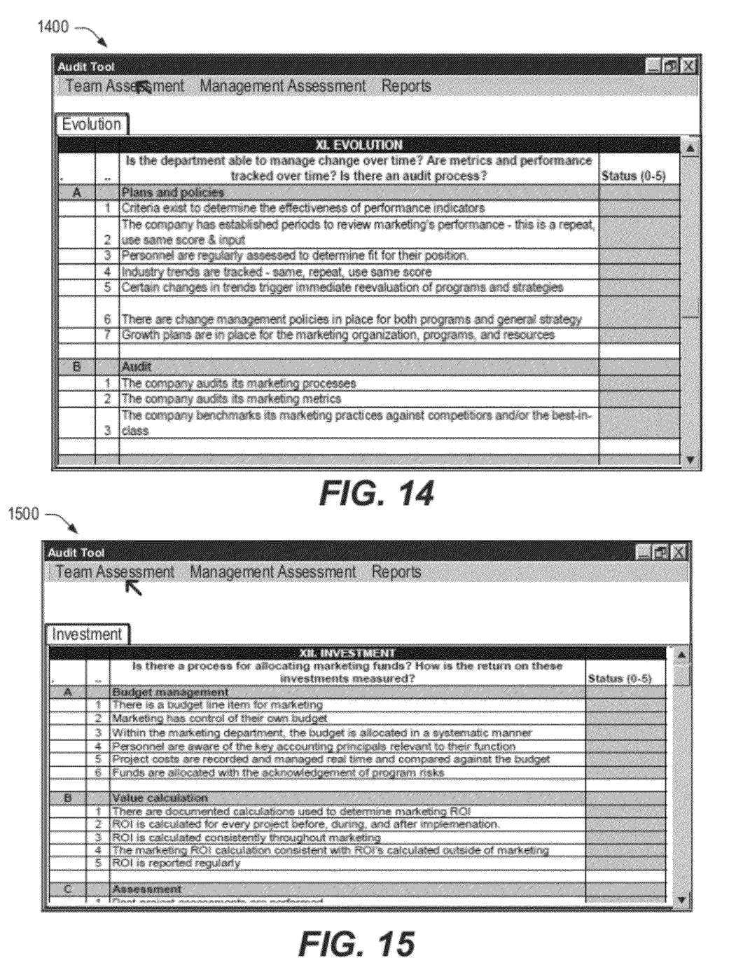

FIG. 14 is an embodiment of a user interface 1400 for receiving user data related to evolution (change) of the organization. User interface 1400 includes questions and user-selectable options for acquiring information about whether the department is able to manage change over time. As described above, the user answers each of the questions using a numeric rating on a scale of zero to five. An example that includes some of the additional inputs is included within Appendix A. Once the data is entered, the user may select a “submit” or “next” button (not shown) at the bottom of the page.

FIG. 15 is an embodiment of a user interface 1500 for receiving user data related to investment of marketing funds. User interface 1500 includes questions and user-selectable options for acquiring information about whether there is a process for allocating marketing funds and whether or how a return on such investments are measured. As described above, the user answers each of the questions using a numeric rating on a scale of zero to five. An example that includes some of the additional inputs is included within Appendix A. Once the data is entered, the user may select a “submit” or “next” button (not shown) at the bottom of the page.

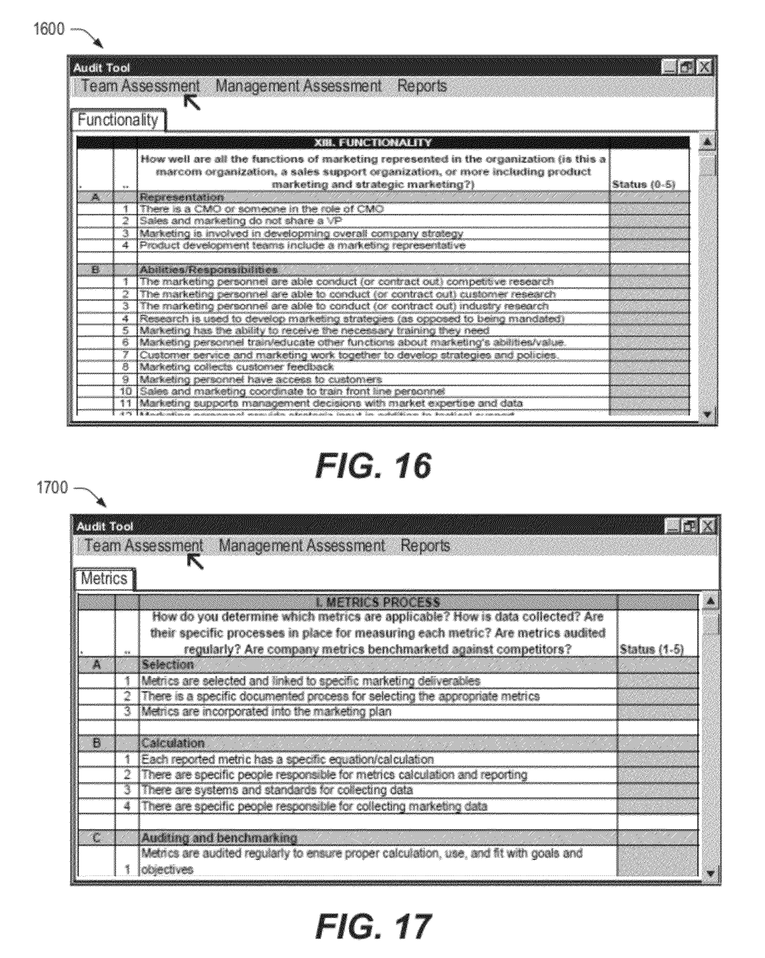

FIG. 16 is an embodiment of a user interface 1600 for receiving user data related to functionality of the organization. User interface 1600 includes questions and user-selectable options for acquiring information about how well the functions of marketing are represented within the organization. User interface 1600 includes questions about marketing's representation within the organization, marketing personnel abilities, and so on. As described above, the user answers each of the questions using a numeric rating on a scale of zero to five. An example that includes some of the additional inputs is included within Appendix A. Once the data is entered, the user may select a “submit” or “next” button (not shown) at the bottom of the page.

FIG. 17 is an embodiment of a user interface 1700 for receiving user data related to metrics processes. User interface 1700 includes questions and user-selectable options for acquiring information about how the organization determines which metrics are applicable, how data is collected, what specific processes are in place for measuring each metric, and so on. User interface 1700 also includes questions about whether metrics are audited regularly and whether company metrics are benchmarked against competitors. As described above, the user answers each of the questions using a numeric rating on a scale of zero to five. An example that includes some of the additional inputs is included within Appendix A. Once the data is entered, the user may select a “submit” or “next” button (not shown) at the bottom of the page.

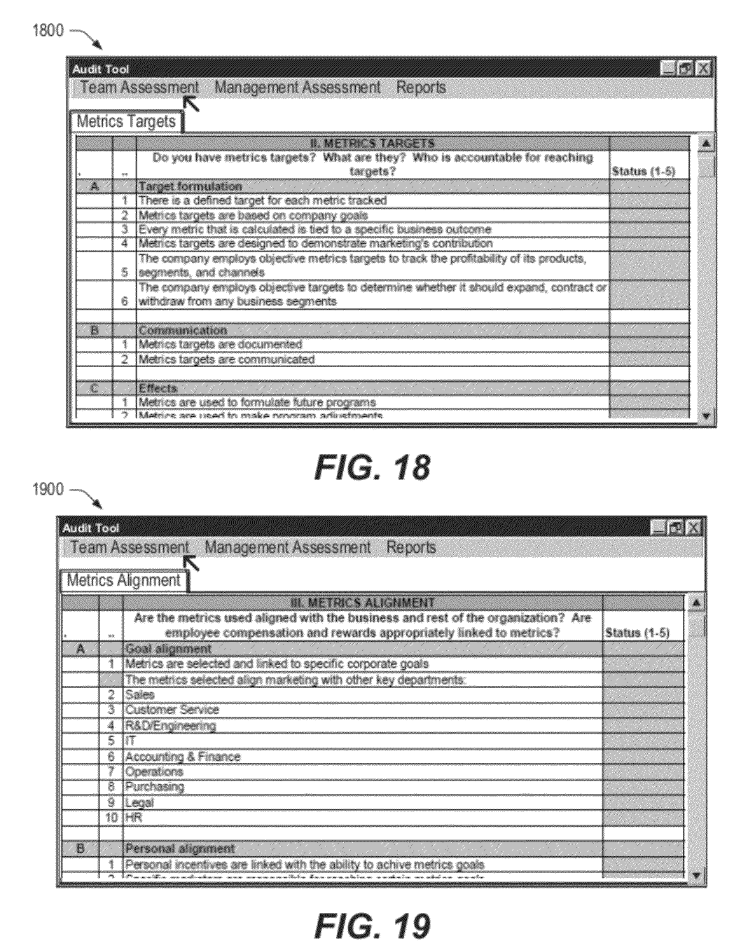

FIG. 18 is an embodiment of a user interface 1800 for receiving user data related to metrics targets. User interface 1800 includes questions and user-selectable options for acquiring information about whether the organization has metrics targets, what are the metrics targets, and who is accountable for reaching the metrics targets. As described above, the user answers each of the questions using a numeric rating on a scale of zero to five. An example that includes some of the additional inputs is included within Appendix A. Once the data is entered, the user may select a “submit” or “next” button (not shown) at the bottom of the page.

FIG. 19 is an embodiment of a user interface 1900 for receiving user data related to metrics alignment. User interface 1900 includes questions and user-selectable options for acquiring information about whether the metrics used are aligned with the business and with rest of the organization and whether employee compensation and rewards are appropriately linked to metrics. As described above, the user answers each of the questions using a numeric rating on a scale of zero to five. An example that includes some of the additional inputs is included within Appendix A. Once the data is entered, the user may select a “submit” or “next” button (not shown) at the bottom of the page.

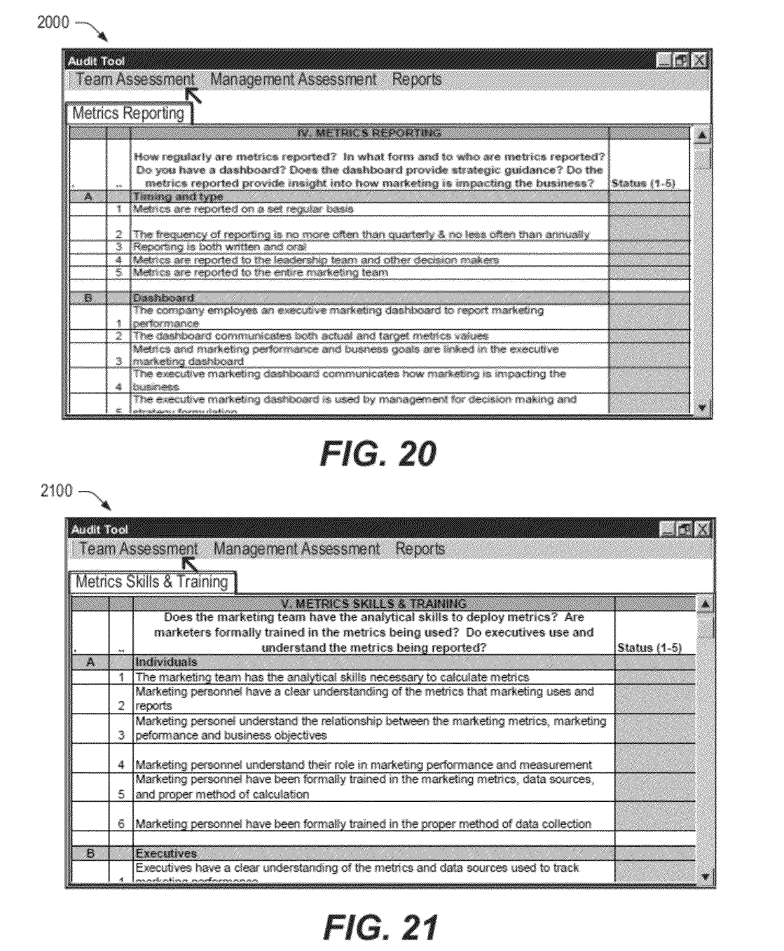

FIG. 20 is an embodiment of a user interface 2000 for receiving user data related to metrics reporting. User interface 2000 includes questions and user-selectable options for acquiring information about how regularly metrics are reported, to whom, and in what form. Further, user interface 2000 includes questions about whether the metrics reported provide insight into how marketing is impacting the business. As described above, the user answers each of the questions using a numeric rating on a scale of zero to five. An example that includes some of the additional inputs is included within Appendix A. Once the data is entered, the user may select a “submit” or “next” button (not shown at the bottom of the page.

FIG. 21 is an embodiment of a user interface 2100 for receiving user data related to metrics skills and training. User interface 2100 includes questions and user-selectable options for acquiring information about whether the marketing team has the analytical skills to deploy the metrics, whether the marketers are formally trained in the metrics being used, and whether the executives use and understand the metrics being reported. As described above, the user answers each of the questions using a numeric rating on a scale of zero to five. An example that includes some of the additional inputs is included within Appendix A. Once the data is entered, the user may select a “submit” or “next” button (not shown at the bottom of the page.

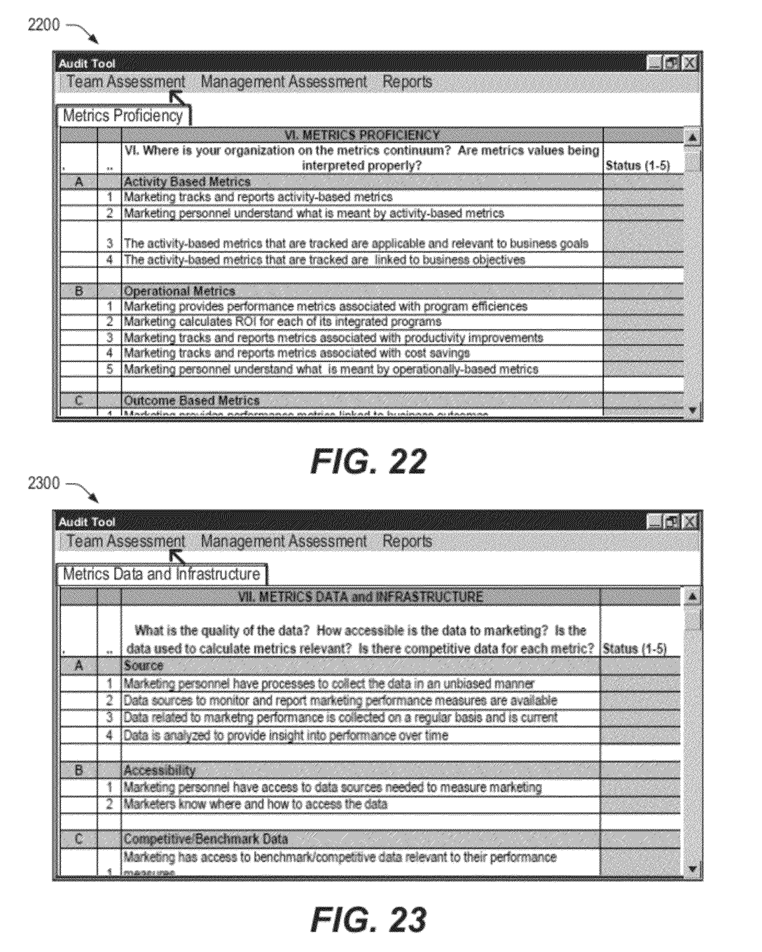

FIG. 22 is an embodiment of a user interface 2200 for receiving user data related to metrics proficiency. User interface 2200 includes questions and user-selectable options for acquiring information about where the organization is on a metrics continuum and whether metrics values are being interpreted properly. As described above, the user answers each of the questions using a numeric rating on a scale of zero to five. An example that includes some of the additional inputs is included within Appendix A. Once the data is entered, the user may select a “submit” or “next” button (not shown at the bottom of the page.

FIG. 23 is an embodiment of a user interface 2300 for receiving user data related to metrics data and infrastructure. User interface 2300 includes questions and user-selectable options for acquiring information about the quality of the data, the accessibility of the data to marketing, and the relevance of the data for calculating the metrics. As described above, the user answers each of the questions using a numeric rating on a scale of zero to five. Further, user interface 2300 includes queries about whether there is competitive data for each metric. An example that includes some of the additional inputs is included within Appendix A. Once the data is entered, the user may select a “submit” or “next” button (not shown) at the bottom of the page.

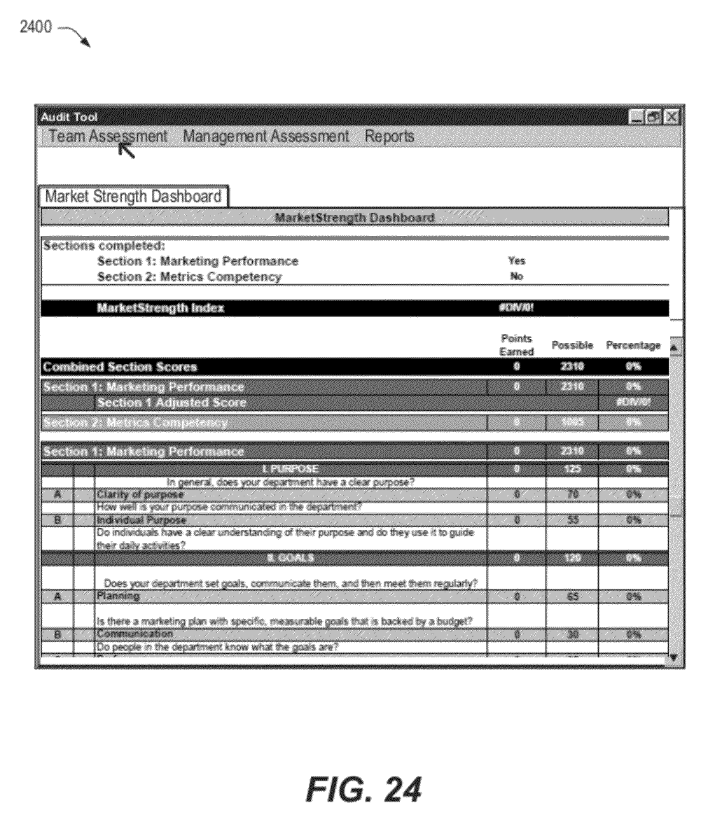

FIG. 24 is a diagram of an embodiment of a user interface 2400 including an example of a market strength dashboard illustrating the combined section scores for the marketing organization. In the illustrated diagram, the marketing performance section includes the purpose and goals sections and some of their subcategories. In an example, the user may double-click on the section headings to expand and/or collapse the section to view the subcategories. An example that includes some of the additional scores/outputs is included within Appendix A. The user may access the reports menu to generate an overall assessment report, which produces graphs based on the data, text explaining the results, and various scores.

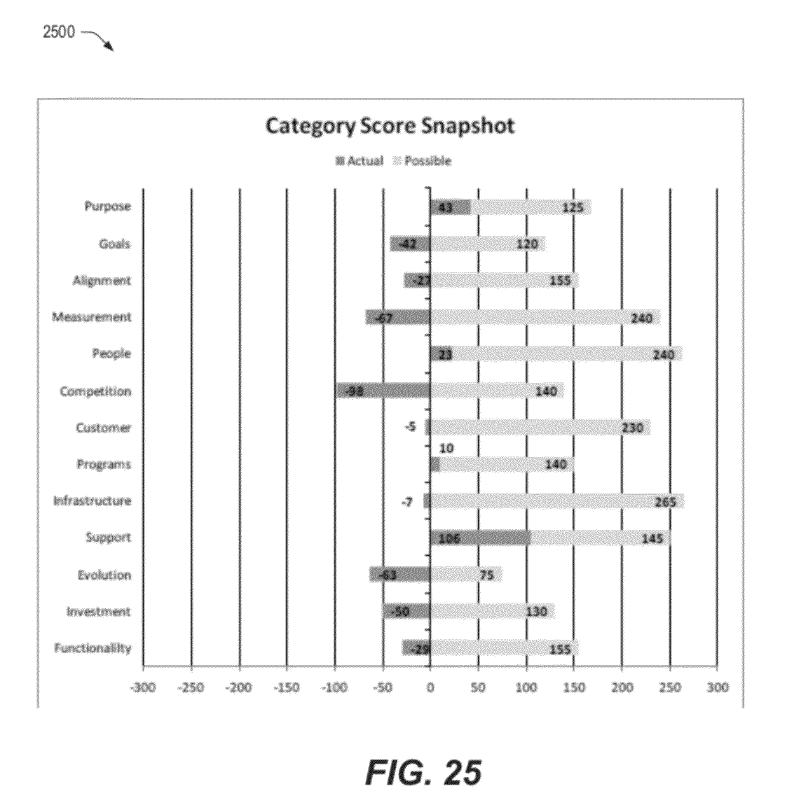

FIG. 25 is a chart of an example of a category score snapshot 2500 produced by the system of FIG. 1 for a particular marketing organization. Category scores snapshot 2500 depicts the actual score versus the possible score of the marketing organization across the thirteen categories. Category score snapshot 2500 reveals both poor scores and some positive scores. The totality of scores from all thirteen categories translates into a low value/low contribution. In this example, the marketing organization received an overall performance score of minus thirty-six (−36) out of a possible score of two thousand forty (2,040).

In illustrated example of the category score snapshot 2500, the competition category and the measurement category received the lowest category scores. The marketing organization's score is lowest in the competition category, with a score of −98 out of a possible score of 140. The competition category examines marketing organization's ability to establish a business case for its programs. The second lowest score is in the measurement category with a score of −67 out of a possible score of 240. The Measurement Category evaluates the ability of the marketing organization to define business outcomes, measure its contribution and impact, and account for the investments it makes on behalf of the company.

In the illustrated example, the marketing organization received its highest score in the category of Support with a score of 106 out of a possible score of 145. The Support Category represents the adequacy of the resources within the firm and within the department, such as equipment, management access and support, and adequacy of access to business information and priorities to enable the Marketing department to successfully perform. In this instance, adequate resources and support exist for marketing to achieve its goals, yet improved communication from management is needed. One factor that contributes to these scores is the lack of clear direction and purpose set by the company. While assessing the functionality category, the scores indicate that the marketing organization primarily acts as a tactical unit. While the scores in the support category are above average, management needs to provide more clear communication about the specific measurable outcomes it expects marketing to deliver.

In the illustrated example, the marketing organization is strong tactically and weak on strategy. If the company wants a marketing organization that can participate and lead the organization in developing marketing strategies that integrate strategic business planning, that can identify and pursues new opportunities, and that has the direction and skills to specifically measure business outcomes, then the company may need a different kind of marketing organization in order to take the corporate strategy to the next level.

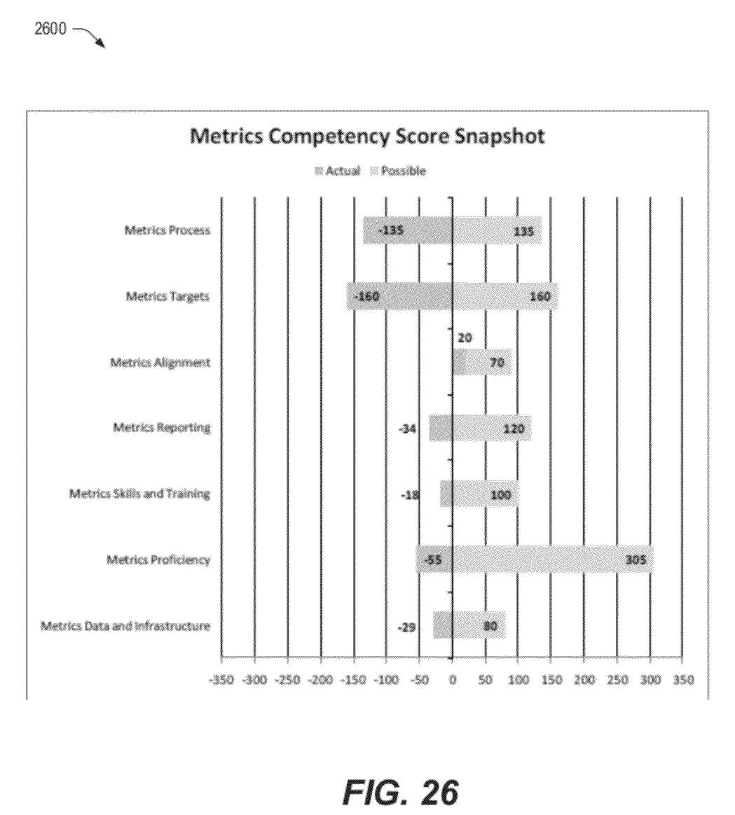

FIG. 26 is a chart of an embodiment of a metrics competency score snapshot 2600 produced by the system of FIG. 1 for a particular marketing organization. In this example, the marketing measurement and performance target setting is almost non-existent, as shown in metrics competency score snapshot 2600. Overall scores in the metrics proficiency category indicate a lack of fundament processes designed to align marketing's initiatives with key metrics to effectively help the organization make more informed decisions about how to grow the business.

in the illustrated example of the metrics competency score snapshot 2600, the highest possible positive score for the Metrics Processes is 135, and the highest possible score for Metrics Targets is 160. In this example, the marketing organization received the maximum negative score in both of these sub-categories; a −135 for Metrics Processes and a −160 for Metrics Targets. These scores indicate that the marketing organization has no processes to approach any metrics measurement activity whatsoever.

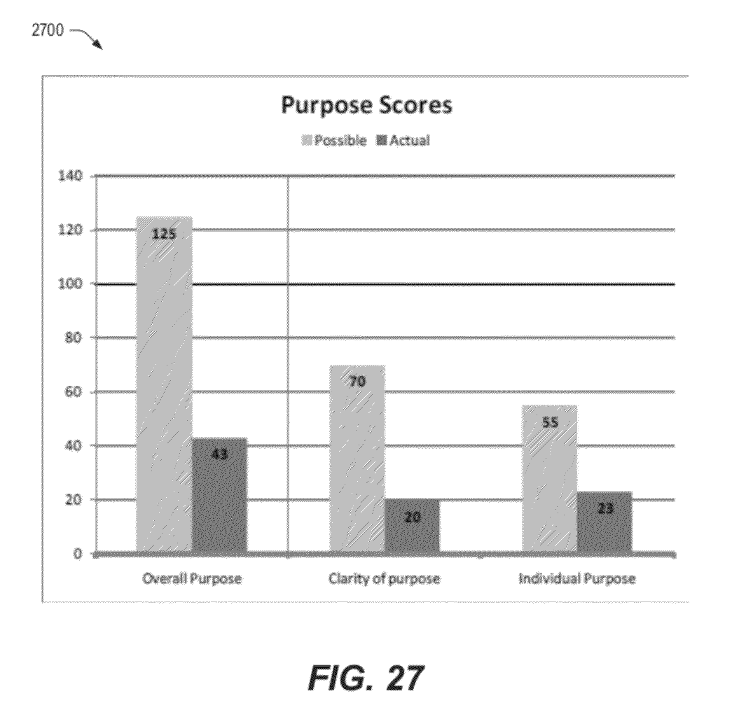

FIG. 27 is a bar graph 2700 of an embodiment of purpose scores produced by the system of FIG. 1 for a particular marketing organization. Bar graph 2700 depicts the overall purpose, clarity of purpose, and individual purpose scores based on the user inputs. In this instance, the actual purpose scores fall below fifty percent of the possible scores, indicating that the purpose may not be clearly defined.

In this example, the purpose score is 43 out of a possible score of 125 indicating the marketing organization, as a department and individually, does not have a well-defined overall purpose. The clarity of purpose score is a 20 out of a possible score of 70, which represents that there is no clear agreement across the company regarding the true purpose the marketing organization serves or should serve and the specific results it expects marketing to deliver. This is especially true in regards to segmentation and an expectation that marketing's purpose is to align initiatives with business outcomes and goals.

In this example, the individual purpose score of 23 out of a possible 55 mainly reflects poor scores in this sub-category due to a lack of alignment with the overall goals of the department and unclear success factors for each individual position in the department. In reviewing the results, management provided specific results it expects marketing to achieve. One specific purpose and expectation of marketing involves targeting and segmenting both existing and prospective member markets. Specifically, management expects the marketing organization to research and use data to develop offers and programs to specifically target, segment and qualify new and existing members. Specific comments might include:
i. expect mass customization and segmentation. The military and civilian customers have a different dynamic. What are the differences?
ii. expect marketing to make the phone ring with specific targeted offers.
iii. Though marketing gets people in the door, they need to do a better job at getting the right people in the door.

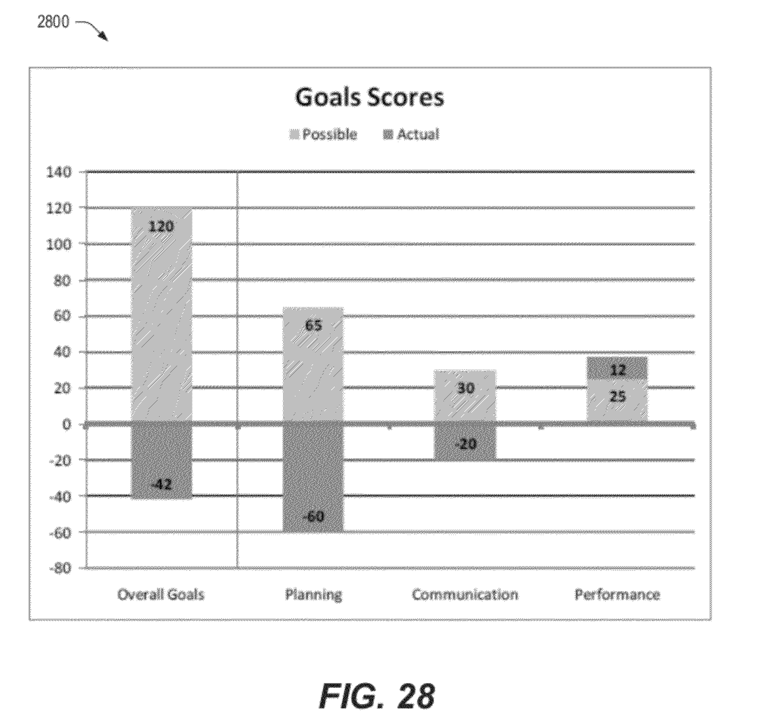

FIG. 28 is a bar graph 2800 of an embodiment of goals scores produced by the system of FIG. 1 for a particular marketing organization. Bar graph 2800 depicts the overall goals scores as well as planning goals, communication goals, and performance goals. On the actual performance goals are in a positive range, indicating that the marketing organization is underperforming. Well-defined goats enable the department to prioritize its time, direction, and areas of focus. The Marketing department must have established, well-defined goals. For best value, they must be measurable and communicated effectively throughout the organization.

In the illustrated example of FIG. 8, the overall goals score of −42 out of a possible 120 reflects the marketing department's absence of processes to define goals, conduct strategic planning, communicate initiatives and evaluate its performance. Planning scores of −60 out of a possible 65 indicates that the marketing organization does a poor job in this category. The planning category of the marketing audit tool 126 measures if marketing has a written marketing plan with well defined goals, key performance indicators (KPIs), and metrics tied to business goals.

In a particular example where a written marketing plan includes goals, these goats may lack quantitative, measurable, metric-focused outcomes and may remain predominantly activity-based. Best-in-class marketers measure specific metrics that link marketing efforts to overall business goals. These marketers and their companies consistently demonstrate higher performance in four areas: rate of customer acquisition, rate of customer retention, annual increase in gross revenues, and return on marketing investment.

In the illustrated example of FIG. 28, the communication score is a −20 out of a possible score of 30. Clearly, communication with all departments is a critical factor in setting goals tied to current and future business outcomes. However, it appears that communication between marketing and the rest of the organization's departments is somewhat limited. This poor communication score may reflect the lack of a formal, standardized process for discussing and setting strategic goals or planning marketing initiatives. In addition, in a case where standardized processes are lacking, the marketing plan is often not well-circulated or communicated across the organization.

Regarding performance, the score of 12 of out a possible 25 provides little evidence that the marketing organization tracks its performance in a rigorous manner. It appears that the measurement is largely subjective, with little attention to how performance ties back to specific business goals.

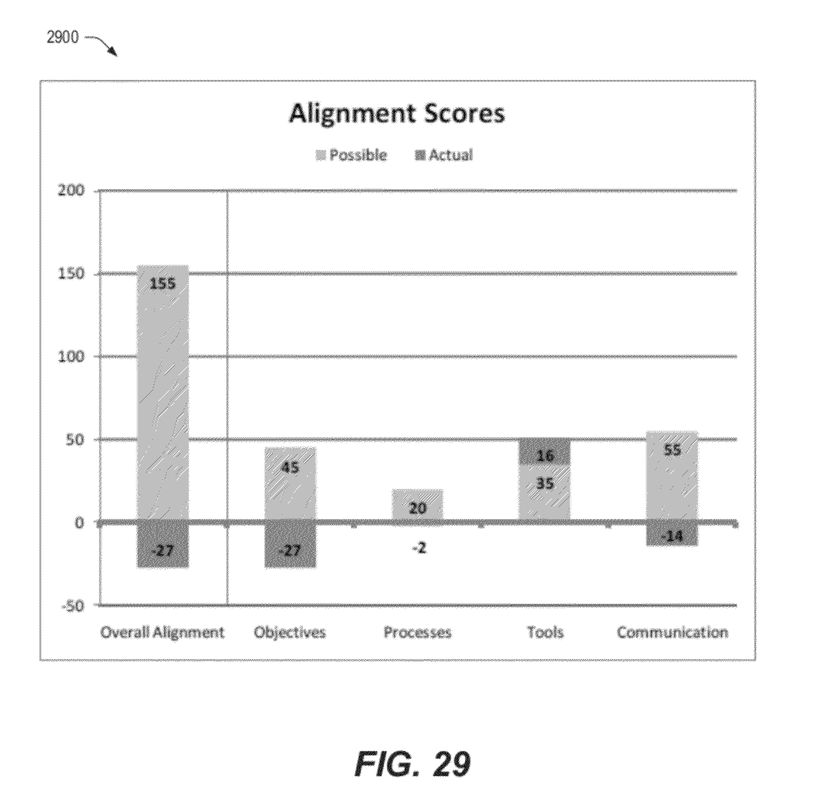

FIG. 29 is a bar graph 2900 of an embodiment of alignment scores produced by the system of FIG. 1 for a particular marketing organization. Bar graph 2900 depicts the overall alignment as well as the alignment with respect to the business objectives, processes, tools, and communication. Marketing audit tool 126 uses four categories for evaluating alignment: objectives, processes, tools, and communications.

In this example, the overall alignment score is a −27 out of a possible 155, which reflects that the marketing organization is not well-aligned. The objectives score a −27 score out of a possible score of 45. Processes to conduct strategic planning also score low with a −2 out of a possible score of 20. Communication across the organization, with a score of −14 out of a possible score of 55, indicates the marketing organization is not regularly meeting with key departments to establish agreed upon strategic initiatives.

The tools themselves do not appear to be a major barrier as indicated by a score of 16 out of 35. This is the highest score in the alignment category. However, specific expertise to use these tools and the processes to initiate, gather, analyze and interpret the correct data clearly is a barrier. Processes for data collection and review appear to be “upon request” and are relegated primarily to tactical uses. Assessment interviews by a user may reveal that marketing data are collected on program and direct mail response rates, current interest rates, deposit and loan balances, members, services per household, mailing list clean up, etc. Most of this data is to support the preparation, execution and, to some degree, evaluation of tactical initiatives.

In terms of processes, the most glaring omission is the lack of formal documented processes to create and communicate the Annual Marketing Plan. In addition, it was revealed early on in the overall assessment that there was no clear and consistent process to gain budget approval for marketing programs or to communicate the status of executed marketing programs.

With the above-described portion of the marketing audit tool 126, one or more users can evaluate the performance of a marketing organization as a whole. Based on the data described in the above-examples, the marketing organization serves primarily a tactical function and has not demonstrated, as currently staffed, the strategic, metrics-focused, data-driven prowess that is expected from highly functioning marketing departments. Without extensive training in marketing disciplines related to aligning marketing objectives with clear measurable business outcomes, the marketing organization cannot provide the necessary analysis, strategic input and guidance to support strategic growth initiatives of the company.

Based on the purpose, goals, and alignment scores, it appears that the company would receive more value from its marketing organization and marketing investments when the marketing team is integrated into the strategic decision-making processes, which integration will require a paradigm shift on the part of both marketing and the organization to expand marketing's role beyond the tactical to the strategic. If both the company leadership and the marketing organization can make this shift, the marketing organization can grow to become an integral part of the operation and a valuable and necessary member of the company's executive decision-making team. The deficiencies indicated by low scores in measurement, goals, and evolution may reflect a lack of processes, of clearly articulated expectations, and of current and future skill sets to enable the marketing organization to grow and evolve to demonstrate corporate value.

Marketing audit tool 126 can include one or more recommendations for the overall marketing organization in its audit report. For example, the audit report may recommend that the marketing organization will need to make more frequent contributions and recommendations regarding business outcomes, marketing objectives and marketing strategy to expand beyond the tactical to the strategic. Further, the audit report may recommend that the leadership define quantifiable business outcomes and establish procedures for interaction between leadership and marketing to unify the marketing organization with the goals and with the organization as a whole.

If the company wants the marketing organization to gather and analyze market and customer intelligence, provide strategic input, develop competitive differentiation and segmentation, support new business opportunities, grow customer/member value and develop quantifiable measurable metrics tied to business outcomes, the marketing organization should evolve to be more than a tactical unit. The marketing audit tool 126 may include (in its audit report) a recommendation that the company define a new marketing position whose primary role is to analyze, track and interpret data and analysis to develop strategic decisions and programs and work with the management to communicate, convey and align marketing initiatives with business outcomes. This role would be in addition to and separate from the creative/tactical arm(s) of the marketing organization. The audit report may further recommend hiring at least one other person to assist in program creation, execution, implementation and program evaluation and analysis. This person should have expertise or training in strategic data analysis including data mining, use of systems and tools, data collection, interpretation and communication and overall appropriate marketing skill sets that are aligned with marketing's purpose. Thus, the audit report would recommend building a marketing organization that is educated about the business of key marketing disciplines and best practices. Other recommendations can include instilling a culture of accountability within the marketing organization, which will require the marketing organization to have the tools and capabilities such as the metrics dashboard to measure and report on its value.

In addition to or in lieu of the overall assessment, it is possible to acquire more granular information about the marketing organization, including data about individual skills within the marketing organization, using the marketing audit toot 126. This more granular data is acquired using the workflow skills assessment module 130 as discussed below with respect to Section B.

### B. The Workflow Skills Assessment

Highly functional marketing organizations leverage distinctive capabilities and processes to improve efficiencies and effectiveness. Such highly-functional marketing organizations tend to be highly integrated because most of the work in the organizations spans across different knowledge and skill domains. Our work and others have found best-in-class marketing organization leverage two overarching best practices:
1. Defining and managing the links between the customer and various processes within the firm; and
2. Developing knowledge and skills, processes and deploying systems and tools related to managing and enhancing the connection between customers (intermediate and end users who purchase the good/service), products (goods for services), and service delivery (ancillary actions involved in providing the goods/services).

This second best practice encompasses the skills and knowledge associated with performing the functions within the marketing workflow process. As marketing professionals hone their knowledge and skills they improve their effectiveness and efficiencies in performing the work of marketing.

It is extremely difficult, perhaps impossible, for an individual to be proficient in all of the skills associated with the marketing workflow, which is why the marketing discipline is often divided into marketing functions. Embodiments of systems and methods described below gather information about the marketing operations, which relate to twenty-seven distinct operations that comprise the marketing workflow. These workflow operations can be grouped into five key marketing areas: strategic marketing (pre-sale), product marketing/go-to-market, opportunity development, post sale/customer marketing, and marketing performance management (marketing operations).

Strategic marketing (pre-sale) refers to a group of distinct operations that relate to pre-sale marketing activities. For example, such strategic marketing includes 1) Market research and requirements; 2) Market segmentation and sizing; 3) Market analysis; 4) Market strategy; 5) Business case and roadmaps; 6) Partner and channel identification, selection, recruitment and management; and 7) Marketing plan and budget.

Product marketing/Go-to-Market refers to a group of distinct operations that relate to the marketing and sale of the product. Product marketing/Go-to-Market includes 8) Product requirements and specifications; 9) Product/customer validation; 10) Target market persona, role, profiling; 11) Product go-to-market strategy and plan; 12) Product pricing analysis, strategy, packaging; 13) Product positioning, brand architecture and messaging strategy and plan; 14) Market traction; and 15) Product portfolio management.

Opportunity development refers to a group of distinct operations for developing market opportunities. Such opportunity development can include licensing opportunities, strategic partnerships, and the like. Opportunity development can include 16) Sales enablement; 17) Account and target prospecting; 18) Marketing communication and demand generation; and 19) Field marketing/sales support.

Post-Sale Customer Marketing refers to a group of distinct operations for developing customer relationships and word-of-mouth type marketing. Post-sale customer marketing includes 20) Customer relationship management; 21) Customer on-boarding; 22) Account Management; and 23) Customer training.

Performance Management/Operational refers to a group of distinct operations for managing the marketing program, including budgeting, planning, and evaluation activities. Performance management can include 24) Opportunity management and scoring; 25) Pipeline management and performance; 26) Customer loyalty and satisfaction; and 27) Marketing measurement, reporting and management. Each of the above-identified marketing workflow operations can be broken down into various “sub-skills”. An example of the list of sub-skills are included in the attached Appendix B.

The systems and methods disclosed below include a marketing workflow skills assessment tool that explores an individual's skill and a group's skills related to these twenty-seven marketing workflow areas. In particular, the system prompts the users to answer a plurality of questions and/or to rank themselves and/or the marketing team across a wide range of skills.

In a particular example, the user information determines how the user is invoiced for accessing the system. In one instance, the user may be charged on a per-case basis. In other instance, the user may be charged for a block of cases. Other invoicing strategies are also possible, including hourly, transactional, etc. For example, the user may be charged only when the audit report is generated, thereby allowing the user to enter and gather information, revise the information and so on, but each time the user generates an audit report based on the information, the system 102 would generate an invoicing event.

Organization data acquisition module 128 uses an in-depth interview, manual or online survey approach to understand the leadership team's performance expectations and concerns (perception of gaps) and the personnel's current skill level and performance (sometimes the skills exist but not the performance and vice versa). Once the data is acquired or in response to a user selection, workflow skills assessment 130 produces a skills assessment (audit) report with recommendations for improving the marketing organization. It is important to remember that this is a skills assessment, not a job performance appraisal nor an assessment of whether participants understand the scope and responsibilities of their job. The purpose is to understand what areas of the marketing workflow the team has mastered and what areas need improvement; not whether the participants believe they need these skills to perform their jobs. It is possible for an individual to have proficiency in one sub-skill in a workflow hut not in others. The skills assessment report is provided to remote device 150 and/or to display device 106 and includes information that provides insight into which workflow areas individuals and the organization has proficiency and where there are opportunities to make improvements.

In an example, a user of remote device 150 accesses a web page provided by web server 124 to create a new case, which is stored in cases 136. Marketing audit tool 126 provides one or more web pages including user-selectable options (such as buttons, pull-down menus, text input fields, clickable links, and other options), text input fields, and other elements, which facilitate a process of collecting information about a marketing organization.

In one instance, the information collection process is performed by an analyst who asks questions of the various individuals and enters the information via the remote device 150 or via one or more input devices 104. In another instance, each person of interest logs in from their own computer via network 112 to answer the questions themselves. The prompts can include instructions, survey questions, and examples that facilitate the data collection process.

Once the data is collected, the user responsible for the audit process accesses a reporting menu, triggering the workflow skills assessment module 130 to analyze the collected information to produce a marketing audit report and/or to automatically generate recommendations for improving the marketing organization.

in an example, some of the marketing workflow operations are weighted, and their relative weights determine the importance of a particular score for the purpose of evaluating the efficiency and skill of the individual and/or the team. The information can be averaged, scaled, normalized, weighted, or otherwise processed to determine a resulting score. It is generally the resulting score (and not the raw score) that is presented in the results. However, in some instances, the raw score may be used or included with the resulting score.

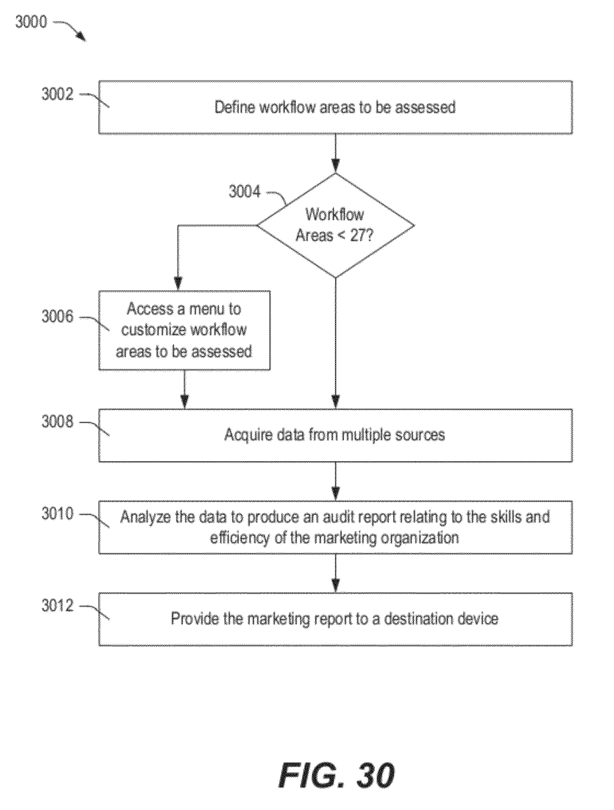

While the above-discussion mentioned the twenty-seven workflow skills that can be included in the assessment, in some instances, a sub-set of the twenty-seven workflow skills may be used. In a particular example, the assessment process can be customized to a particular organization. An example of a method of customizing the assessment process is described below with respect to FIG. 30.

FIG. 30 is a flow diagram of an embodiment of a method 3000 for customizing an assessment process for a particular marketing organization. At 3002, a user defines workflow areas to be assessed. If the user determines that not all of the twenty-seven workflow areas require assessment, the user may elect to select a subset of such areas. Marketing audit tool 126 defaults to acquire and analyze all twenty-seven categories of information, but marketing audit tool 126 can be configured to reduce the categories. Advancing to 3004, if the user elects to customize the data acquisition, the method advances to 3006 and the user the user accesses a menu to customize the categories. Method 3000 advances to 3008 and data is acquired either through interviews or by providing user interfaces with survey questions to each of the users. Returning to 3004, if the user elects not to customize the data acquisition, method advances to 3008 and data is acquired.

In an example, each interview or survey lasts less than an hour. Once the data is acquired, method 3000 advances to 3010 and processor 120 executes workflow skills assessment module 130 to analyze the data to produce an audit report relating to the skills and efficiency of the marketing organization. Proceeding to 3012, computing system 102 provides the marketing report to a destination device, such as display device 106 or remote device 150.

During the step of acquiring the data (block 3008), each person to be interviewed is presented with the same questions in the same order and asked to respond to each question with a rating of 0-5 with the ratings explained as follows:
i. A zero “0” indicates that even though the words make sense the person does not know what the process/skill is or what it entails.
ii. A rating of “1” indicates the person understands what the process/skill entails but does not know the tasks, techniques, and/or methods needed to complete the task.
iii. A rating of “2” indicates the person understands and can complete the process/skill and the associated tasks with significant coaching and guidance.
iv. A rating of “3” indicates the person can independently complete the process, skill and associated tasks.
v. A rating of “4” indicates the person has mastery of the process, skills and associated tasks and has work products that would serve as useful guide and resource to others.
vi. A rating of “5” indicates the person has mastery of the process/skills and associated tasks, excellent work product examples, and can teach/coach others on the processes, skills, tasks, and techniques.

In some instances, individuals may be asked to explain the sub-skills/tasks associated with the operation. In an example, organization data acquisition module 128 (in response to receiving a data entry of “3” or higher in response to a particular question) may prompt the user with follow up questions to verify the user's skills. Those sub-skills and tasks may be further assessed by a person conducting the interviews (if the interview process is conducted by an individual), such as by asking participants open-ended questions. In an example, such open-ended questions can include questions such as what marketing areas they would like to learn, where they feel they could be better utilized, and what they believe they should be accountable for.

Upon completion of the interviews, the scores are entered into marketing audit tool 126. In an example, pressing a “submit” button at the end of the survey causes the user input to be provided to marketing audit tool 126. In response to receiving the data, marketing audit tool 126 synthesizes the data and plots the resulting information into workflow charts by operation with an overview of each operation and a score for each operation by individual. Workflow skills assessment module 130 analyzes the data and produces a skills assessment report including scores ranging from 0-5 for each individual and for the marketing group. The scores are as follows:
i. A zero, “0”, indicates there is no competency in this area.
ii. A one, “1”, indicates limited competency and extensive education and skills training and development are needed.
iii. A two, “2”, indicates some skills competency but the contributor cannot work independently and needs skills training, coaching and guidance
iv. A three, “3”, indicates adequate competency and that with some training and documented processes and work product examples the contributor can complete the tasks independently.
v. A four, “4”, indicates the contributor is proficient and white additional training may be needed to keep skills current, they can work independently and have work product and documented processes to contribute to the organization's database.
vi. A five, “5”, indicates the contributor is a master coach and possesses the initiative to keep their skills current and up-to-dale.

In operation, marketing audit tool 126 provides one or more user interfaces or screens including user-selectable elements and data inputs for receiving user inputs from participants within the marketing organization as well as within the management of the organization. Management may have a different perspective with respect to the marketing skills and efficiencies than those within the marketing organization. Further, the interfaces may present different questions and the respective answers may be weighted differently.

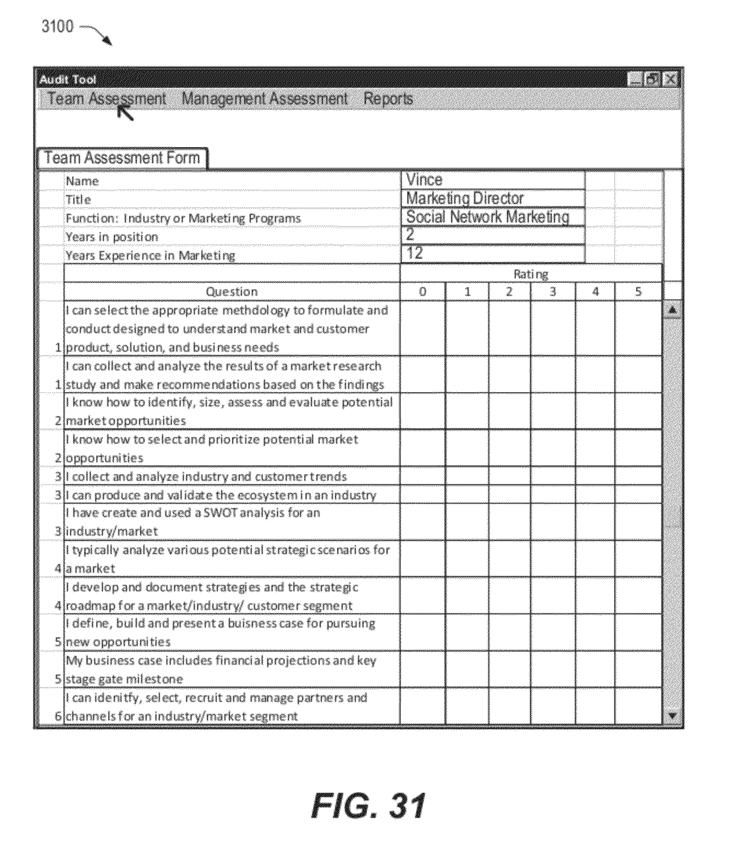

It should be understood that, whether the user entering the information is the participant (interviewee) or an interviewer, the data acquisition process may proceed through a process of data entry into various forms. An example of a team assessment form is described below with respect to FIG. 31.

FIG. 31 is a diagram of an embodiment of a graphical user interface 3100 provided by a computing system, such as the computing system 102 of FIG. 1, and configured to receive team assessment data about each member of a marketing team from the perspective of the members of the marketing team for use in providing the marketing performance and accountability audit. Graphical user interface 3100 includes a first menu labeled “Team Assessment”, a second menu labeled “Management Assessment”, and a third menu labeled “Reports.” in this instance, the “Team Assessment” menu is selected, and a form is presented in response thereto that is labeled “Team Assessment Form.”

The Team Assessment Form includes inputs for receiving the name, title, function, years in the position, and year of experience in marketing for a particular interviewee or participant. The Team Assessment Form further includes a list of questions to which the user responds by rating his/herself or the interviewee on the scale of 0-5. One example question asks the user to rate his/herself on a scale of 0-5 based on the statement “I can select the appropriate methodology to formulate and conduct a program designed to understand market and customer product, solution, and business needs.” There are hundreds of possible questions that can be asked. An example of a data entry sheet for the Team Assessment Form including some possible questions is attached in Appendix B.

At the bottom of the form, the user interface includes a button labeled “Submit” or “Next” (not shown), which, when selected by the user, posts the information to computing system 102 for processing using marketing audit tool 126. The user may then select the management assessment menu or the reports menu to proceed to other options.

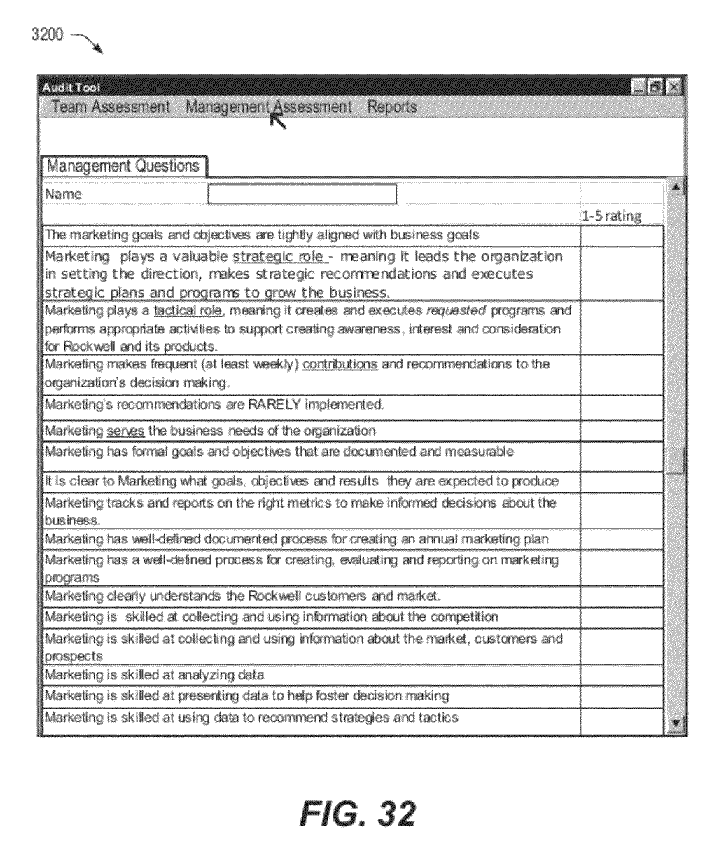

FIG. 32 is a diagram of an embodiment of a graphical user interface (GUI) 3200 provided by a computing system, such as the computing system 102 of FIG. 1, and configured to receive assessment data about the marketing team from the perspective of management for use in providing the marketing performance and accountability audit. The user may access GUI 3200 by selecting the Management Assessment menu. Upon selection, marketing audit tool 126 presents GUI 3200 for presenting Management Questions to a user (interviewee) associated with management. GUI 3200 includes a first input for receiving the name of the interviewee and a second input for receiving ratings for each of the statements. While the rating is depicted as being within a range from 1 to 5, it should be appreciated that that the rating may alternatively be configured to range from 0 to 5 (as discussed above).

Management questions differ from those presented to the marketing organization. For example, the interviewee associated with management is presented with the statement “The marketing goals and objectives are tightly aligned with business goals.” Management may have an opinion regarding such alignment that may differ (sometimes wildly) from that of a participant within the marketing organization. As the user proceeds to the end of the survey, GUI 3200 presents the user with a button labeled “Submit” or “Next” that, when selected, causes the data to be posted to computing system 102. The user may then select the reports menu, for example, to proceed.

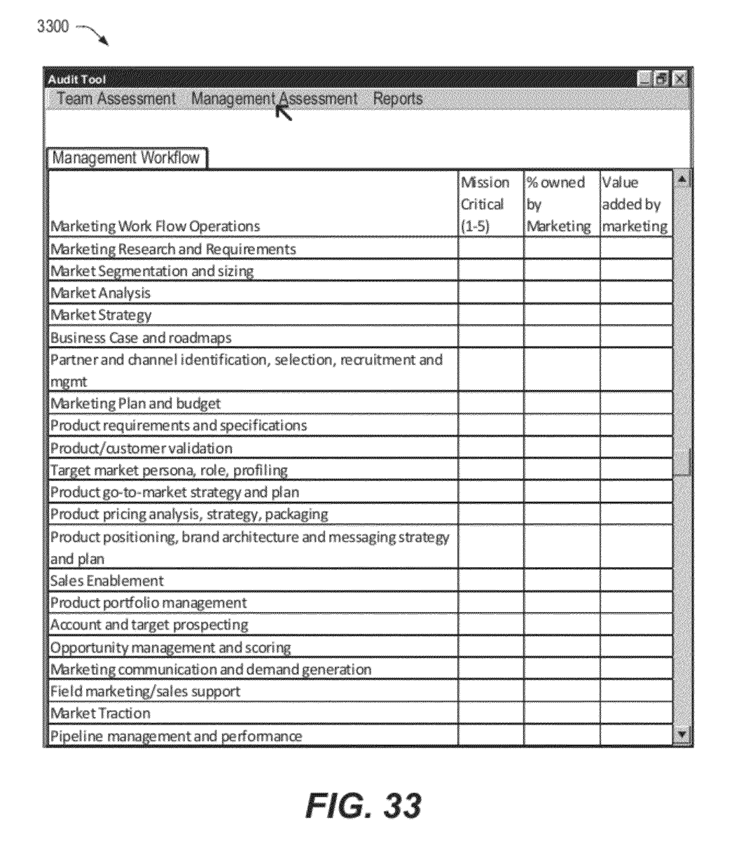

FIG. 33 is a diagram of an embodiment of a graphical user interface (GUI) 3300 provided by a computing system, such as the system of FIG. 1, and configured to receive management workflow data for use in providing the marketing performance and accountability audit. GUI 3300 includes a form labeled “Management Workflow” that allows the user to rate the criticality of each of the twenty-seven distinct marketing workflow operations, to indicate the percentage of the responsibility for each operation that is directly attributable to marketing, and to rate the value added by marketing. As previously mentioned, management's view of the marketing organization's efficiency and effectiveness and their contribution to the business may vary from that of marketing's. Data entered in this form provides a great deal of fodder for further discussions between management and marketing, which communication can improve the organization. Additional questions that can be included within the Management Workflow form are attached in Appendix B, GUI 3300 includes a button labeled “Submit” or “Next” (not shown) at the bottom of the form. When selected, the button causes GUI 3300 to post the data to computing system 102.

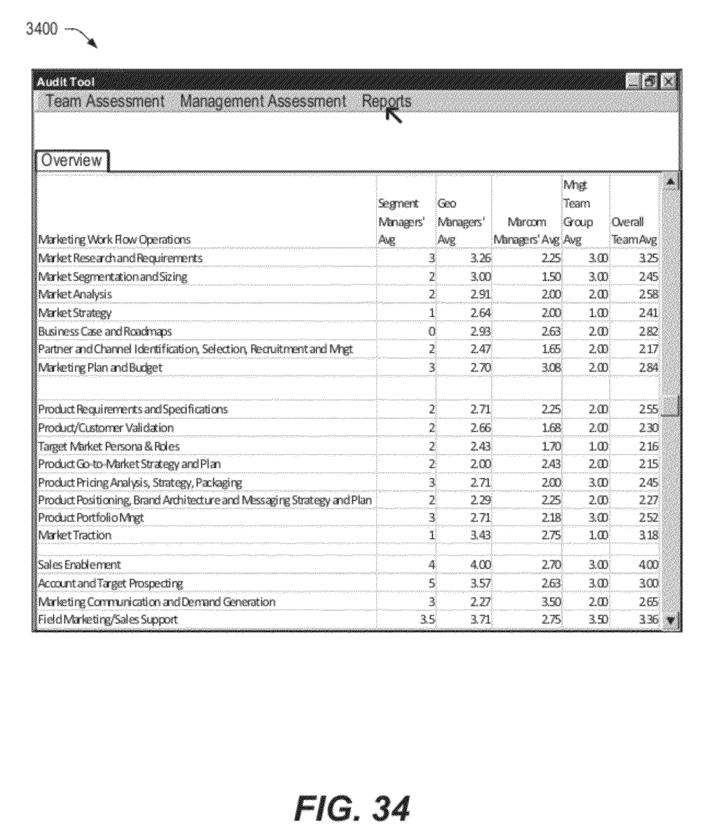

FIG. 34 is a diagram of an embodiment of a graphical user interface (GUI) 3400 provided by a computing system, such as the system of FIG. 1, and configured to display results from the marketing performance and accountability audit. GUI 3400 may be accessed by selecting the Reports Menu. GUI 3400 includes a synthesis of data collected from the marketing participants and from the management team for each of the twenty-seven workflow categories. In particular, GUI 3400 includes the segment manager's average score, the Geo Managers average score, the Marketing/communications (MARCOM) Managers average score, the management teams group average, and the overall team average. An example of a GUI including at least a portion of the marketing performance and accountability audit is included in Appendix B.

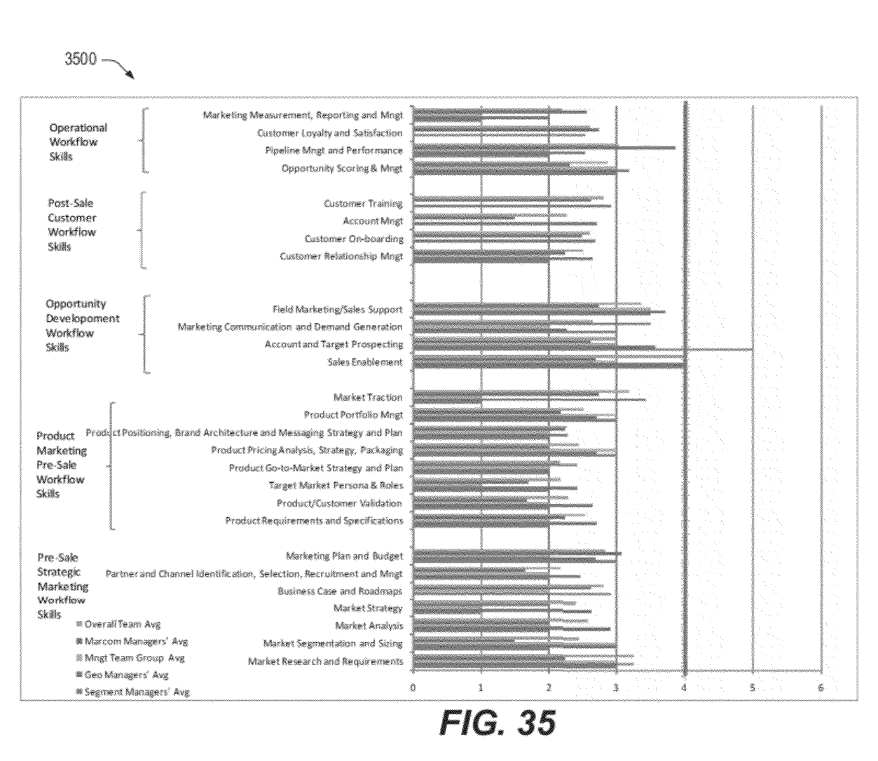

In general, the marketing performance and accountability audit report includes numeric data, descriptive text including text explaining the results and text presenting recommendations for improving marketing operations. One example of a chart that provides an overall snapshot of the skills competency and proficiency for the industry and program managers and as a group is described below with respect to FIG. 35.

FIG. 35 is a graph 3500 of an embodiment of an overall snapshot of the skills competency and proficiency for the industry and program managers as a group. In the illustrated example, graph 3500 includes a line graph depicting overall competency and proficiency across the marketing workflow operations. In this particular instance, the information is limited. Documented processes and work product examples would go a long way toward supporting this group. In this example, most of the participants recognize they have limited competency and proficiency across the marketing workflow operations. None of the individuals or members of the marketing leadership team believe that any person on the team has the skills or work product and processes to “proficiently perform” any of the marketing workflow operations. As a group, neither the industry nor the program manager teams' skills related to the marketing workflow achieve a rating of 4 or higher (although some individuals as seen later do). In this example, the scores may not be surprising if the industry manager's years of experience are within the industry itself and if the program managers are relatively young (or inexperienced) practitioners.

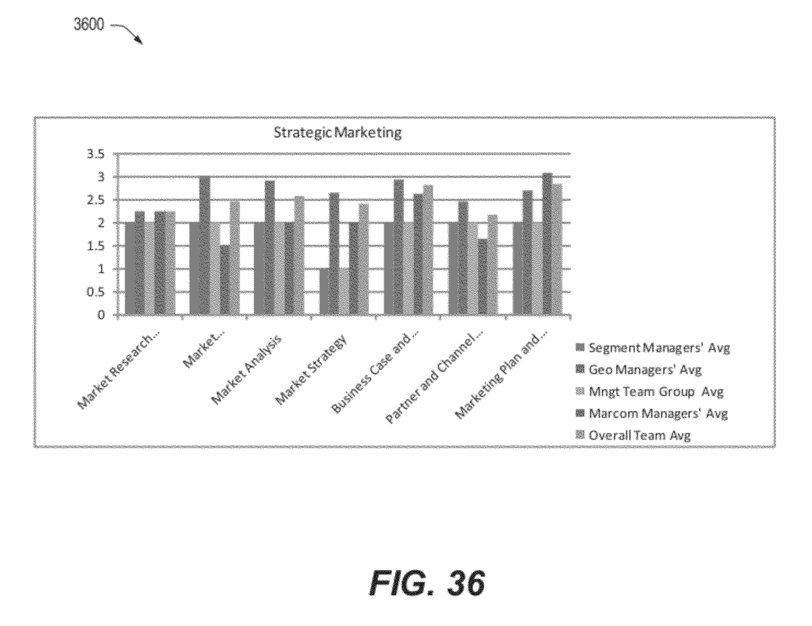

Graph 3500 provides a snapshot of the organization. However, it is useful to explore the information further. In this instance, as discussed with respect to FIG. 36, both industry and program managers, in this case, have focused their skills on opportunity development. The industry managers in general see their primary responsibility is to support “closing” deals within their industry and as a result a number of them have developed fairly solid competencies when it comes to sales support and market traction within their industry. This emphasis on “deal flow” is also recognized by the program managers, and as a result, the program managers have honed their competencies around demand generation and pipeline management. An example of a chart to provide a snapshot into the skills competency and proficiency for each operation is described below with respect to FIG. 36.

FIG. 36 is a graph 3600 of an embodiment of a snapshot of skills, competency and proficiency of the marketing team for several marketing operation categories. Graph 3600 provides a bar graph illustrating each group within the marketing team with respect to the various marketing operation categories.

In the illustrated example, the workflow operations associated with strategic marketing are relatively weak among the team, and this weakness is recognized by both the team members and marketing management. In graph 3600, market analysis scores highest with industry managers having a rating of 3. Marketing Plans and Budget scores highest with program managers with a rating of 3.1. Management perceives marketing plans and budgets as the overall team's greatest strength.

With the exception of market research and analysis, there is a relatively wide gap between the perception of the industry manager's competency with the workflow operations associated of strategic marketing and that of the management's perception of their competency. Regardless, both groups recognize that this is not an area of proficiency.

The marketing leadership team perceives market strategy as the weakest skill among the strategic marketing workflow operations for both industry and program managers. Strategic marketing is a primary skill for marketing professionals. These skills enable the organization to identify the best opportunities to pursue that will generate profitable revenue, sustain a competitive advantage, accelerate innovation, and improve market penetration and domination. These skills are important for organizations that serve more than one market, operate in more than one region, and offer more than one product. Skills in this area involve the overall market and brand strategy and platform, competitive positioning, and the marketing plan. Marketing professionals with these skills improve a firm's performance through enhanced marketing methods and improved customer loyalty by determining how the organization engages customers and uses new sales and marketing methods to grow and increase market domination.

Strategy is one of the most difficult skills for any marketer to develop. Until the strategy skill is developed, strategy is one area that organizations will add personnel who already posses a well developed process and skill set or outsource this to an organization that specializes in market strategy. Strategy is often closely aligned with opportunity development. An example of a chart depicting workflow operations competency with respect to opportunity development is described below with respect to FIG. 9.

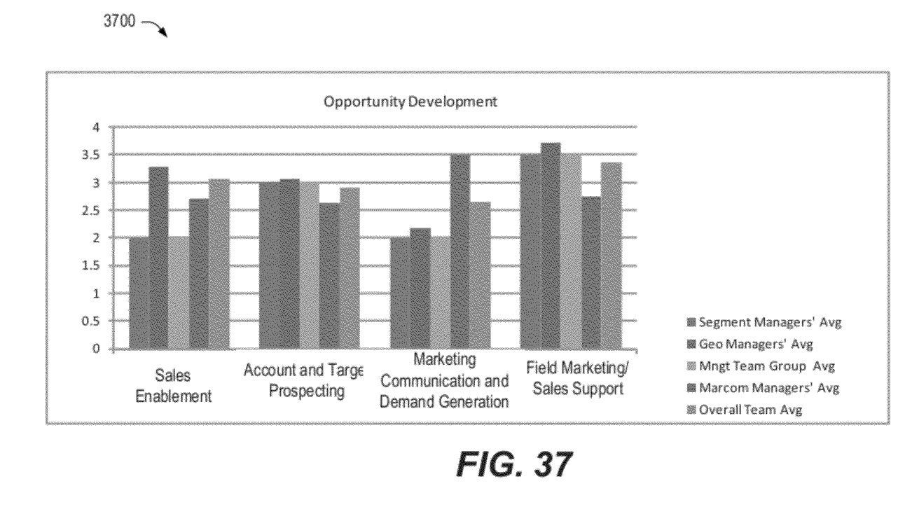

FIG. 37 is a graph 3700 of an embodiment of an opportunity development overview depicting opportunity development skills of the marketing team. In graph 3700, workflow operations designed to support the sales organization and develop and close opportunities are the strongest for these two teams. In this example, the industry managers' perceive these operations as their (primary role, to serve and be on demand to the sales team in the support of new deals, perhaps even at the expense of other aspects of marketing.

In the illustrated example, field marketing and sales support have the highest rating for all workflow operations by the industry managers with a rating of 3.7, marginally above the management team's rating of 3,5, followed by the industry manager's rating of 3.3 of their skills and processes related to sales enablement. While the management team actually rated the program managers' skills in terms of sales support higher than the program managers' own ratings (3.5 vs. 2.7, respectively), the program managers have these skills and use them regularly.

As one might expect, the program managers see marketing communication and demand generation among their strongest skills, with a rating of 3.5, their second highest score across all the operations. However, marketing communication and demand generation has one of the largest gaps in terms of the perception, where the management team rates the marketing group in this area with a score of 2. This discrepancy (3.5 versus 2) represents a disconnect that needs to be addressed within the organization. Better communication between management and marketing will not only enhance understanding, but will also improve the efficiency of the marketing department.

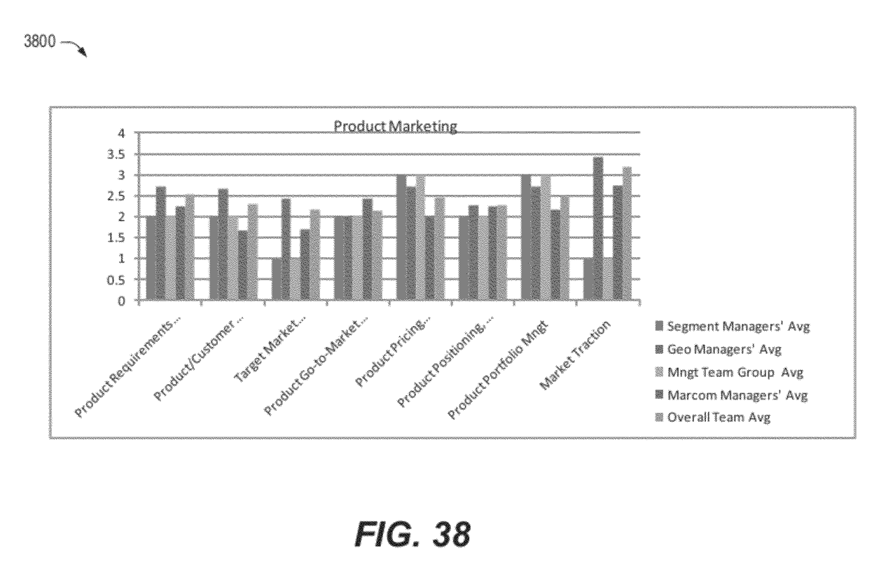

FIG. 38 is a graph 3800 of an embodiment of a product marketing overview depicting the product marketing skills of the marketing team. In graph 3800, it appears that industry and program managers perceive themselves as relatively competent when it comes to creating market traction for products and services in their industry (with scores of 3.4 and 2.7, respectively). However, the marketing management team scores them much tower (with a rating of 1), representing one the widest gaps between industry managers and the marketing management team. In this example, most industry managers perceive product marketing skills and processes among their overall weakest areas. It appears that in reality that this is truly a weak area that should be addressed. Improving product requirements and specifications skills, target marketing persona and roles skills are important workflow areas that would help support and potentially accelerate opportunity development.

Another important workflow area that needs to be addressed is the product go-to-market strategy and plan. Product Go-to-Market Strategy is a particularly weak area for the entire group. If the company adds new products to its portfolio, this workflow area may become a critical skill set, and the lack of marketing skills in this area could hamper launch and adoption targets. Options to address this area include using a third party, adding personnel who already have this expertise, or developing this skill among existing members. Regardless of the option, this is an area that should receive investment.

It is not uncommon to separate product marketing from industry or segment marketing. Product marketing as a function is typically responsible for marketing the product to prospects, customers, and others. Generally it is their responsibility to define new products, position products competitively and to bring new products to market. In this capacity, product marketing defines what products will be offered, who will be the target customers, how the product will reach these customers, what channels will be used, how the product will be priced and packaged, and how customers will be introduced to the product. To provide this function, the product marketer should be able to conduct the research and analysis needed to develop the foundational elements used by marketing communication and sales to communicate and promote the product to the market, prospects and customers. These product marketers need to ensure product strategy, positioning and messaging complement the organization's overall market and brand strategy and positioning. In some organizations, this function is referred to as a “brand manager”.

Product marketing differs from product management, which is usually focused on driving new product development. Product management primarily addresses the “nuts and bolts” of product development and takes a product's requirements from the sales and marketing personnel to create a product requirements document, which wilt be used by the development, engineering, manufacturing teams to build the product. In some organizations, product management actually oversees the development of the product.

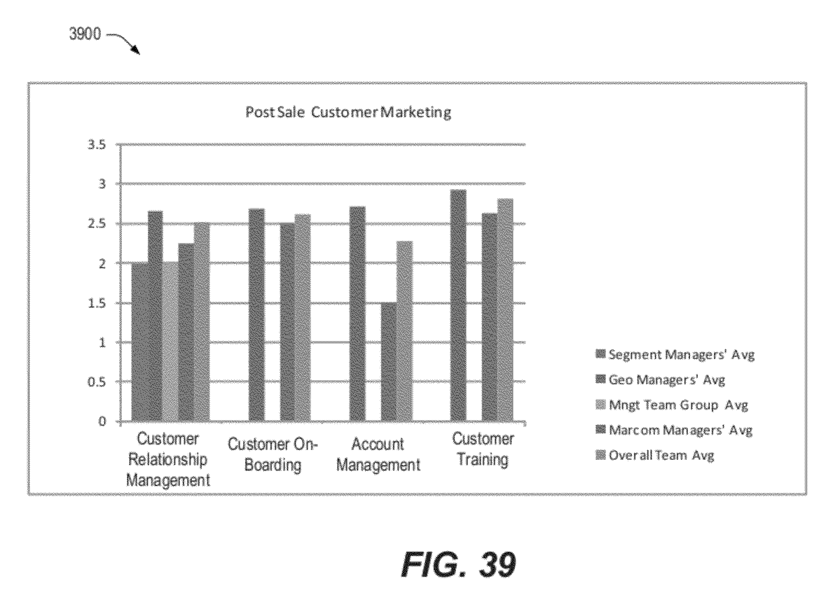

FIG. 39 is a graph 3900 of an embodiment of a customer marketing overview depicting the customer marketing skills of the marketing team. It is common for many marketing organizations to emphasize the workflow operations associated with customer acquisition at the expense of skills and processes associated with customer retention. In graph 3900, similar to the strategic marketing skills, post-sale customer marketing is weak across the teams. These skills are essential for creating customer advocates, developing customer references, facilitating new product adoption among existing customers, and generating up-sell and cross-sell opportunities.

Even though account management within the sales organization, customer service, and in some organizations professional services may be tasked to support these operations or in some organizations the professional services function, an important role of marketing is retaining and increasing the value of existing customers.

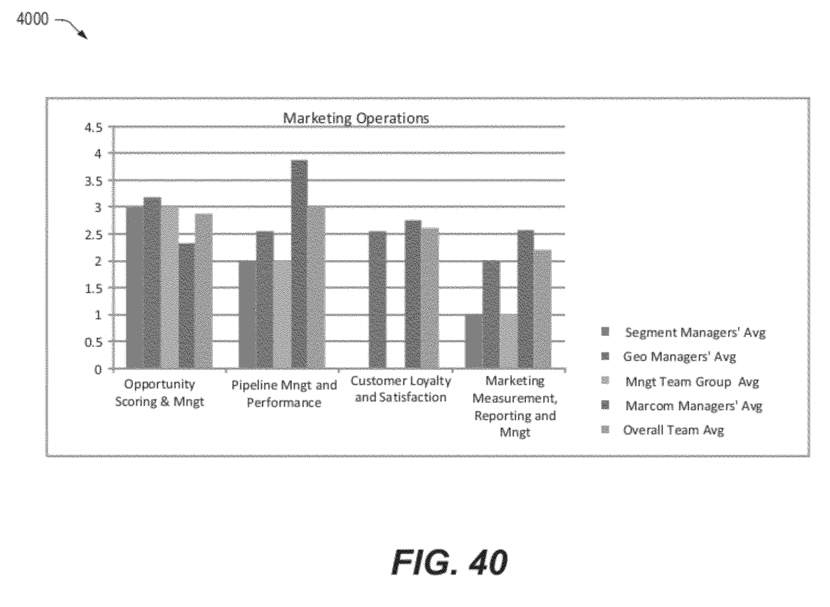

FIG. 40 is a graph 4000 of an embodiment of a marketing operations overview depicting the overall marketing operations of the marketing team. Marketing Operations workflow enables an organization to integrate processes, technology and metrics to help run the marketing organization as a fully-accountable business unit. This is the “last frontier” for many marketing organizations.

Based on graph 4000 which illustrates the output for this example, the results for this particular example support the recommendation that the entire group reflected in the example could benefit from a “general” marketing education workshop to better understand all the functions and to adopt and work from the same vocabulary. The entire group may then further benefit from specific training relating to the gathering and analyzing of market requirements and opportunities, marketing strategy, bringing new products to market, understanding the customer buying process, personas and roles in order to improve the front end of opportunity development and better support marketing communication, demand generation, and field marketing efforts. The collected data indicates that the team needs processes, templates, and work product examples for supporting skills development for all team members. Creating a library of work product examples and a database of processes should be among the first steps taken to support this group. Several facilitated process mapping sessions would serve multiple purposes and provide an initial start to skills development, a consistent approach, and a valuable resource for the entire team. This process alone would improve overall efficiency and the overall quality of the work product.

Marketing audit tool 126 generates a series of recommendations for improving the marketing operations. In this example, marketing audit tool 126 would recommend the following overall actions be taken by the enterprise:
i. Until the team is sufficiently trained bring in external/third party market strategy experts.
ii. Adding a person with strong strategy skills and processes.
iii. Train existing personnel in the area, of market research and analysis to help foster fact-based decisions and as the initial steps for supporting strategy skill development.

Further, marketing audit tool 126 may provide more specific recommendations, such as the following recommendations:
i. Develop or adopt a segmentation process or methodology that can be deployed across industries to support an apples-to-apples comparison of potential new opportunities.
ii. Create and use a business case template.
iii. Establish and formalize processes for account and prospect selection and prioritization and establish a process for managing field/sales support requests to eliminate the current on-demand ad-hoc approach experienced by many of the industry managers.
iv. For the time being add a product marketing function or integrate product marketing skills into the product development area and develop/adopt a product/customer validation process for new products
v. Train the team on personas and create or adopt a persona/rote template
vi. Write or outsource the development of personas for each primary “buyer”, “user”, and “influencer” within each industry.
vii. Implement a training program and process for new product go-to-market strategy and plan and adopt/develop a go-to-market plan template
viii. Enhance the team's customer marketing skills and encourage/enable program managers to interface with customers and sales team.
ix. Train existing members on current marketing automation and CRM (salesforce.com) systems.
x. Invest in systems and tools to support demand generation and field marketing.
xi. Transition “Carol” (see “Carol” in FIG. 13 below) from a predominantly pre-sale role to one that is more customer and post-sale oriented. This would also provide Carol a clean slate and fresh start.

In today's business climate, all marketers are expected to have measurement and performance management skills. This often requires marketers to receiving analytics and data management training as well as systems training. These skills should be a part of every marketing professionals training plan if only for their own professional development. However, the current skill levels indicate that training should be provided in fundamental marketing areas and establishment of measurable outcome-based marketing objectives beyond “revenue” for each industry.

While the above-descriptions have largely focused on averaged (aggregated) data, an individual breakdown is also available. An example of a summary report that reflects the relative scores of each member of the team is described below with respect to FIG. 13.

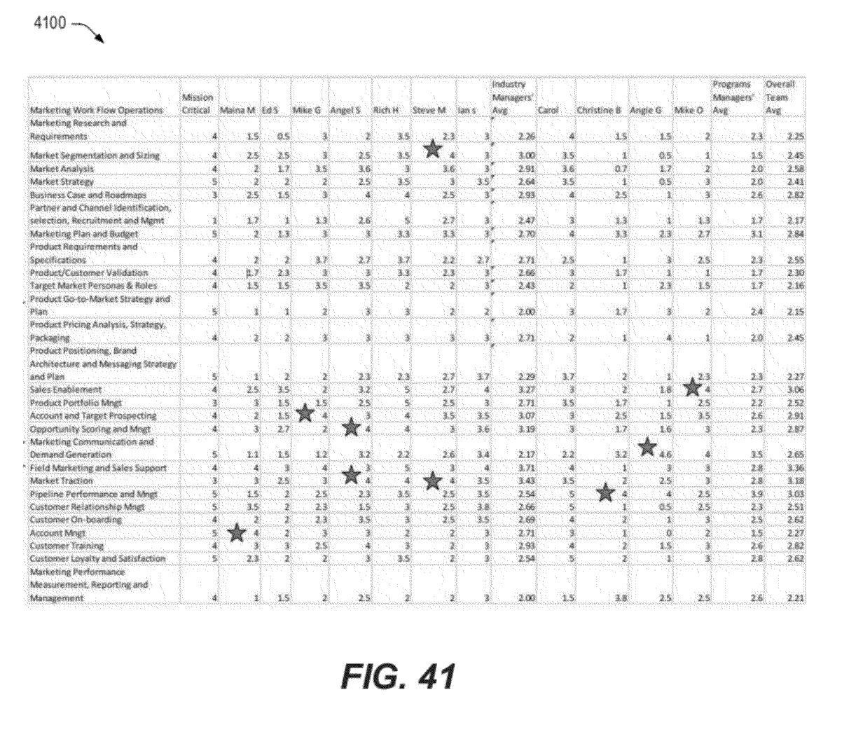

FIG. 41 is a diagram depicting an embodiment of chart 4100 summarizing findings for each workflow operation for each person and providing averages for each group and for the marketing team. Chart 4100 includes each user, the mission “criticality”, the averages (“industry manager” and “overall team”), and other information. In general, chart 4100 provides the individual ratings for each workflow operation by area: strategic marketing, product marketing, opportunity development, customer marketing, and marketing operations and performance management.

The chart uses the following scale for the skill rating for each individual:
i. A zero, “0”, indicates there is no competency in this area.
ii. A one, “1”, indicates limited competency and extensive education and skills training and development are needed.
iii. A two, “2”, indicates some skills competency but the contributor cannot work independently and needs skills training, coaching and guidance.
iv. A three, “3”, indicates adequate competency and that with some training and documented processes and work product examples the contributor can complete the tasks independently.
v. A four, “4”, indicates the contributor is proficient and while additional training may be needed to keep skills current, they can work independently and have work product and documented processes to contribute to the organization's database.
vi. A five, “5”, indicates the contributor is a master coach and possesses the initiative to keep their skills current and up-to-date.

Chart 4100 summarizes the findings for each workflow operation for each person and provides an average for each group and overall team average. Within chart 4100, green stars highlight areas of strength for an individual. While there are a number of areas needing investment, two areas (marketing communication and demand generation and field marketing/sales support), while not exceptional, are adequate enough to justify delaying further skill development in this area until other areas that facilitate those two areas are improved. This does not mean that the individuals perform these areas well. It just means they understand the processes, and they possess adequate skills to perform the operations. Investments in systems, processes and tools should take precedence in these two areas over skills development.

In some instances, chart 4100 may identify master coaches. In this instance, none are identified.

in general, the industry managers see themselves as an extension of the sales organization rather than as marketers and that their primary job is to create leads and support closing deals or develop sales tools (a tactical role). Most of them have served in sales roles and find this role familiar and comfortable, have developed opportunity development skills (such as proposal writing, conducting demos, etc), and have little if any formal marketing training. Almost all of the industry managers began each conversation with a similar disclaimer of “not being a marketing guy,”

The industry managers believe the organization is leveraging their contacts and expertise in their respective industries well, which perpetuates their tactical role. The industry managers would like to play a more strategic role and help drive strategy in their industry, but almost all of the industry managers need improved market strategy skills. They acknowledge this is an area where they need skill development.

Industry managers also acknowledge they could benefit from learning how to reduce barrier to sales, messaging to decision-makers, and dealing with message clutter. They recognize the need to improve their ability to identify, size and rationalize market opportunities. They also believe they and the organization would benefit from a more formalized product management process, especially when it comes to “feeding” requirements to engineering and product launches. Many would like to understand and learn more about new media, such as social media and social networks. This information is generally gleaned from the data acquisition process.

If the industry managers are expected to serve in more than a tactical rote to support identifying and closing specific opportunities, all of the industry managers needs strategic and product marketing training. In terms of their tactical rote, they need training in the marketing automation and CRM systems, especially salesforce.com. Most industry managers would benefit from having a documented process and work product examples. Most of these folks have been around the block several times and armed with these they could self-improve.

Based on the survey information, it appears that the marketing programs manager would all benefit from more direct customer and sales team interaction. The focus on industries is requiring the program managers to come up a fairly steep “learning curve” for each industry. A more complete example of report including chart 4100 is depicted in Appendix B.

In general, computing system 102 provides the web pages or other user interfaces to remote device 150 for receiving the data. Once collected, the user interacts with the Reports Menu to access one or more of the reports described above, and/or other reports. While the above-reports depict the information in bar charts and tables, it should be appreciated that the results information may be presented in other forms as well. In an example, some of the information may be presented in pie charts and other types of graphs. Some of the variations are depicted in appendix B.

In conjunction with the systems and methods described above with respect to FIGS. 1-41, a computing system 102 includes a marketing audit tool 126 configured to prompt a user (or multiple users) through a process of acquiring information about a marketing organization and/or about individuals within the marketing organization. The marketing audit tool 126 processes the acquired data to automatically generate a report including text, charts, and synthesized data indicating the relative strength of the marketing organization over multiple categories and/or the relative workflow skills of the individuals within the marketing organization. In the embodiments described above with respect to FIGS. 1-41, a user may selectively enter data for one or both types of assessments, and marketing audit tool 126 produces an assessment report based on the data provided.

While the above-described examples depicted a marketing audit tool 126 including an organizational data acquisition module 128 and a workflow skills assessment module 130, it should be appreciated that in some instances, the marketing audit tool 126 will include only one such module. In one such instance, the marketing audit tool 126 may be used to perform an overall assessment of the marketing organization. In another such instance, the marketing audit tool 126 may be used to perform a workflow skills assessment.

Although the present invention has been described with reference to preferred embodiments, workers skilled in the art will recognize that changes may be made in form and detail without departing from the scope of the invention.

What is claimed is:

1. A computer-readable medium comprising instructions that, when executed by a processor, cause the processor to:
generate a graphical user interface including text, a plurality of user-selectable options, and text input fields;
receive user input based on the graphical user interface to selectively acquire first data corresponding to a marketing organization as a whole, second data corresponding to groups within the marketing organization, and third data corresponding to individuals within the marketing organization; and
generate at least one audit report based on at least one of the first data, the second data, and the third data.

2. The computer-readable medium of claim 1, wherein the first data comprises multiple categories of interest with respect to the marketing organization.

3. The computer-readable medium of claim 1, wherein the second data and the third data comprise multiple workflow categories with respect to individuals and groups within the marketing organization.

4. The computer-readable medium of claim 1, wherein the at least one audit report includes an overall assessment of the marketing organization based on the first data.

5. The computer-readable medium of claim 1, wherein the at least one audit report includes a workflow skills assessment of the marketing organization based on the second data and the third data.

6. The computer-readable medium of claim 1, further comprising additional instructions that, when executed by the processor, cause the processor to generate metrics tied to business outcomes from the first data, the second data, and the third data.

7. The computer-readable medium of claim 6, further comprising additional instructions that, when executed by the processor, cause the processor to:
receive user input based on the graphical user interface to selectively acquire performance data corresponding to the marketing organization the groups within the marketing organization, and the individuals within the marketing organization; and
score an effectiveness of the marketing organization based on the metrics tied to business outcomes and include the score in the at least one audit report.

8. The computer-readable medium of claim 1, further comprising second instructions that, when executed by the processor, cause the processor to provide the at least one audit report to a display interface for providing the at least one audit report to a display device.

9. The computer-readable medium of claim 1, further comprising second instructions that, when executed by a processor, cause the processor to provide the at least one audit report to a network interface coupled to a network for providing the at least one audit report to a remote device.

10. The computer-readable medium of claim 1, wherein the at least one audit report includes an audit report directed at the marketing organization as a whole.

11. The computer-readable medium of claim 1, wherein the at least one audit report includes an audit report directed at least one of the groups within the marketing organization.

12. The computer-readable medium of claim 1, wherein the at least one audit report includes an audit report directed at least one of the individuals within the marketing organization.

13. A file server system comprising:
a host processor;
a network interface coupled to the host processor and configured to communicate with a remote processor over a network;
a memory coupled to the host processor and adapted to store a marketing audit tool that, when executed by the remote processor, cause the remote processor to:
selectively prompt a user to provide user inputs defining relative strengths and weaknesses of a marketing organization;
selectively prompt a user to provide data defining relative strengths and weaknesses of individuals associated with the marketing organization; and
selectively analyze the user inputs and the data to produce an audit report for the marketing organization and to output the audit report over the network interface.

14. The file server system of claim 13, wherein audit report includes multiple categories of interest with respect to the marketing organization.

15. The file server system of claim 13, wherein the audit report includes an overall assessment of the marketing organization.

16. The file server system of claim 13, wherein the audit report is directed at least one of group within the marketing organization.

17. The file server system of claim 13, wherein the marketing audit tool includes a workflow skills assessment tool.

18. A method comprising:
generating a graphical user interface including text, a plurality of user-selectable options, and text input fields;
receiving user input based on the graphical user interface to selectively acquire first data corresponding to a marketing organization as a whole, second data corresponding to organizations within the marketing organization, and third data corresponding to individuals within the marketing organization; and
generating at least one audit report based on at least one of the first data, the second data, and the third data.

19. The method of claim 18, further comprising:
generating metrics tied to business outcomes from the first data, the second data, and the third data; and
including the metrics in the audit report.

20. The method of claim 18, wherein first data comprises multiple categories of interest with respect to the marketing organization.
